(19) United States
(12) Patent Application Publication
(10) Pub. No.: US 2022/0207606 A1
(43) Pub. Date: Jun. 30, 2022

(54) PREDICTION OF FUTURE OCCURRENCES OF EVENTS USING ADAPTIVELY TRAINED ARTIFICIAL-INTELLIGENCE PROCESSES

(71) Applicant: The Toronto-Dominion Bank, Toronto (CA)

(72) Inventors: Paige Elyse DICKIE, Toronto (CA); Jesse Cole CRESSWELL, Toronto (CA); Satya Krishna GORTI, Toronto (CA); Jianjin DONG, Toronto (CA); Mohammad RAZA, Mississauga (CA); Christopher Patrick CAROTHERS, Oakville (CA); Tomi Johan POUTANEN, Toronto (CA); Maksims VOLKOVS, Toronto (CA)

(21) Appl. No.: 17/180,745

(22) Filed: Feb. 20, 2021

Related U.S. Application Data
(60) Provisional application No. 63/132,692, filed on Dec. 31, 2020.

(51) Int. Cl. G06Q 40/02; G06N 20/20; G06N 5/00; G06N 5/04

(52) U.S. Cl. CPC G06Q 40/025; G06N 20/20; G06Q 50/26; G06N 5/04; G06N 5/003

(57) ABSTRACT

The disclosed embodiments include computer-implemented apparatuses and processes that dynamically predict future occurrences of events using adaptively trained machine-learning or artificial-intelligence processes. For example, an apparatus may generate an input dataset based on first interaction data associated with a prior temporal interval, and may apply an adaptively trained, gradient-boosted, decision-tree process to the input dataset. Based on the application of the adaptively trained, gradient-boosted, decision-tree process to the input dataset, the apparatus may generate output data representative of a predicted likelihood of an occurrence of an event during a future temporal interval, which may be separated from the prior temporal interval by a corresponding buffer interval. The apparatus may also transmit a portion of the generated output data to a computing system, and the computing system may be configured to generate or modify second interaction data based on the portion of the output data.

### CROSS-REFERENCE TO RELATED APPLICATION

This application claims the benefit of priority under 35 U.S.C. § 119(e) to prior U.S. Provisional Application No. 63/132,692, filed Dec. 31, 2020, the disclosure of which is incorporated by reference herein to its entirety.

### TECHNICAL FIELD

The disclosed embodiments generally relate to computer-implemented systems and processes that facilitate a prediction of future occurrences of events using adaptively trained artificial intelligence processes.

### BACKGROUND

Today, many financial institutions extend credit in the form of credit-card accounts, personal loans, and other unsecured lines-of-credit to their customers in accordance with certain terms and conditions, such as a repayment schedule or corresponding interest rate. The terms and conditions associated with the extended credit may be established initially by the financial institutions prior to issuing the credit-card accounts, personal loans, and unsecured lines-of-credit to corresponding ones of the customers and further, the financial institutions may elect to modify one or more of the terms and conditions of the extended credit based on an evolution in the relationships between the financial institutions and the customers, and based on the customer's use, or misuse, of various financial or credit instruments issued by these financial institutions.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data associated with a first temporal interval, and to apply a trained artificial intelligence process to the input dataset. The at least one processor is further configured to execute the instructions to, based on the application of the trained artificial intelligence process to the input dataset, generate output data representative of a predicted likelihood of an occurrence of an event during a second temporal interval. The second temporal interval is subsequent to the first temporal interval and is separated from the first temporal interval by a corresponding buffer interval. The at least one processor is further configured to execute the instructions to transmit at least a portion of the generated output data to a computing system via the communications interface. The computing system is configured to generate or modify second interaction data based on the portion of the output data.

In other examples, a computer-implemented method includes generating, using at least one processor, an input dataset based on elements of first interaction data associated with a first temporal interval. The computer-implemented method also includes, using the at least one processor, applying a trained artificial intelligence process to the input dataset, and based on the application of the trained artificial intelligence process to the input dataset, generating output data representative of a predicted likelihood of an occurrence of an event during a second temporal interval. The second temporal interval is subsequent to the first temporal interval and is separated from the first temporal interval by a corresponding buffer interval. Further, the computer-implemented method includes transmitting, using the at least one processor, at least a portion of the generated output data to a computing system. The computing system is configured to generate or modify second interaction data based on the portion of the output data.

Additionally, in some examples, a tangible, non-transitory computer-readable medium stores instructions that, when executed by at least one processor, cause the at least one processor to perform a method that includes generating an input dataset based on elements of first interaction data associated with a first temporal interval, and applying a trained artificial intelligence process to the input dataset. The method also includes, based on the application of the trained artificial intelligence process to the input dataset, generating output data representative of a predicted likelihood of an occurrence of an event during a second temporal interval. The second temporal interval is subsequent to the first temporal interval and is separated from the first temporal interval by a corresponding buffer interval. Further, the method includes transmitting at least a portion of the generated output data to a computing system. The computing system is configured to generate or modify second interaction data based on the portion of the output data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A and 1B are block diagrams illustrating portions of an exemplary computing environment, in accordance with some exemplary embodiments.

FIGS. 1C and 1D are diagrams of exemplary timelines for adaptively training a machine-learning or artificial intelligence process, in accordance with some exemplary embodiments.

FIGS. 2A and 2B are block diagrams illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of future occurrences of events based on an application of an adaptively trained machine-learning or artificial-intelligence process to customer-specific input datasets, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a corresponding customer are often informed by the customer's relationship with the financial institution and the customer's use, or misuse, of other financial products or services. For example, one or more computing systems of a financial institution (e.g., an FI computing system, as described herein) may obtain, generate, and maintain elements of customer profile data identifying the customer and characterizing the customer's relationship with the financial institution, elements of account data identifying and characterizing one or more financial products issued to the customer by the financial institution, elements of transaction data identifying and characterizing one or more transactions involving these issued financial products, or elements of reporting data, such as credit-bureau data associated with the particular customer. The elements of customer profile data, account data, transaction data, and/or reporting data may establish collectively a time-evolving risk profile for the customer, and the financial institution may base not only a decision to provision the particular financial product or service to the corresponding customer, but also a determination of one or more initial terms and conditions of the provisioned financial product or service, on the established risk profile.

By way of example, the particular financial product or service may include an unsecured credit product, such as a credit-card account, a personal loan, or an unsecured line-of-credit, and the initial terms and conditions imposed on that unsecured credit product may include, but are not limited to, an amount of credit extended to the customer, a repayment schedule, an interest rate, or a penalty imposed upon the customer by the financial institution in response to a determined violation of the initial terms or conditions. Further, and based on additional elements of the customer profile data, account data, transaction data, and/or reporting data generated or obtained subsequent to the issuance of the unsecured credit product, the one or more FI computing systems may perform operations that modify one or more of the initial terms or conditions of the unsecured credit product to reflect the customer's use, or misuse, of the unsecured credit product, a change in the customer's relationship with the financial institution, and additionally, or alternatively, a determined use, or misuse, of other financial products or services. The modifications to the initial terms or conditions may include, but are not limited to, an increase in the interest rate, an acceleration of the repayment schedule or an increase in a scheduled monthly payment, or a request that the customer repay all, or a portion of, an outstanding balance associated with the unsecured credit product.

In some instances, the determination of the initial terms and conditions of the issued credit product by the one or more FI computing systems, and any modification to these initial terms and conditions subsequent to issuance of the credit product to the customer, may be informed by, and may reflect, a risk to the financial institution that the customer will be unable to satisfy the obligations associated with the issued credit product. By way of example, and upon issuance of the credit product to the customer, the financial institution may assume the risk that the customer, at some point in the future, may be unable to submit, or may delay a submission of, one or more scheduled payments associated with the unsecured credit product to the financial institution. The inability to satisfy the obligations associated with the unsecured credit product, e.g., in accordance with the initial or modified terms and conditions, may result in, or may represent, an occurrence of an insolvency event involving the customer. Further, and as described herein, the occurrence of the insolvency event, such as, but not limited to, a personal bankruptcy or a settlement proposed by the customer, may limit an ability of the financial institution to recover fully any funds extended to, or utilized by, the customer through the issued credit product.

To further characterize the risk posed to the financial institution by the issuance of the credit product to the customer, the one or more FI computing systems may analyze the elements of customer profile, account, transaction, or reporting data and generate a corresponding score that characterizes the level of risk associated with issuance of the credit product to the customer. While these computed scores may reflect a probability that the customer may misuse the issued credit product during a current temporal interval, and may characterize a relationship between the customer and the financial institution during that current temporal interval, these computed scores may alone be incapable of characterizing a risk that the customer will experience or be associated with an insolvency event during a future temporal interval. Furthermore, given the increasing volume of the profile, transaction, account, and reporting data maintained by the one or more FI computing systems on behalf of their customers, some existing processes may be incapable of analyzing the elements of customer profile, transaction, account, and/or reporting data, and of generating the corresponding, customer-specific scores, in time frames sufficient to support a real-time determination of the initial terms and conditions of a requested unsecured credit product, or the periodic monitoring of the risk posed to the financial institution by these unsecured credit products subsequent to their issuance to various customers.

In some examples, described herein, a machine-learning or artificial-intelligence process may be adaptively trained to predict a likelihood of an occurrence of an insolvency event involving a customer during a future temporal interval using training data associated with a first prior temporal interval, and using validation data associated with a second, and distinct, prior temporal interval. The machine-learning or artificial-intelligence process may include an ensemble or decision-tree process, such as a gradient-boosted decision-tree process (e.g., XGBoost model), and the training and validation data may include, but are not limited to, elements of the profile, account, transaction, and/or reporting data characterizing corresponding ones of the customers of the financial institution, along with elements of insolvency data identifying and characterizing prior occurrences of insolvency events associated with, or involving, the corresponding customers.

Through the implementation of the exemplary processes described herein, the one or more FI computing systems (e.g., which may collectively establish a distributed computing cluster associated with the financial institution) may perform operations that adaptively, and successively, train and validate the machine-learning or artificial-intelligence process based on corresponding subsets of the training and validation data. Further, the trained machine-learning or artificial-intelligence process (e.g., the trained gradient-boosted, decision-tree process described herein) may further ingest input datasets associated with one or more customers of the financial institution, and based on an application of the trained gradient-boosted, decision-tree process to the input datasets, the one or more FI computing systems may generate elements of output data indicative of a likelihood of an occurrence of an insolvency event involving corresponding ones of the customers during a future temporal interval, such a twelve-month interval disposed between three and fifteen months from a prediction date.

In some instances, the one or more FI computing systems may perform any of the exemplary processes described herein to generate input datasets associated with all, or a selected subset, of the customers of the financial institution, and to apply the trained gradient-boosted, decision-tree process to the input datasets, in accordance with a predetermined schedule (e.g., on a monthly basis). For example, the selected subset may include one or more customers that hold a corresponding unsecured credit product issued by the financial institution, and each of the issued credit products may be subject to a corresponding set of terms and conditions (e.g., as initially established by the financial institution at issuance, or as subsequently modified by the financial institution). As described herein, the one or more FI computing systems may transmit the elements of output data generated through the application of the adaptively trained, gradient-boosted, decision-tree process to the input datasets to one or more additional computing systems associated with the financial institution, which may perform operations that modify the terms and conditions of one, or more, of the unsecured credit products to reflect the likelihood of a future insolvency event involving a corresponding one of the customers.

Further, and as described herein, the one or more FI computing systems may receive, from the one or more additional computing systems, data associated with a request a new credit product by a particular customer of the financial institution. Responsive to the received data, the one or more FI computing systems may perform any of the exemplary processes described herein to generate an input dataset associated with the particular customer, and based on an application of the trained gradient-boosted, decision-tree process to the input dataset, generate output data indicative of the likelihood of a future insolvency event involving the customer. In some instances, the one or more FI computing systems may generate the input dataset associated with the particular customer, apply the trained gradient-boosted, decision-tree process to the input dataset, and generate the corresponding output data in real-time and contemporaneously with the receipt of the data requesting the new credit product. As described herein, the one or more FI computing systems may transmit the generated output data to the one or more additional computing systems, which may perform additional operations that determine whether to issue the new credit product to the customer, or determine initial terms and conditions for the newly issued credit product, based in part on the generated output data.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more of the FI computing systems to predict, in real-time, a likelihood of an occurrence of an insolvency even involving one or more customers of the financial institution during a predetermined, future temporal interval (e.g., via an implementation of one or more parallelized, fault-tolerant distributed computing and analytical protocols across clusters of graphical processing units (GPUs) and/or tensor processing units (TPUs)). These exemplary processes may, for example, be implemented in addition to, or as alternative to, processes through which the one or more FI computing systems compute customer-specific scores indicative of a potential misuse of an issued credit product by a customer during a current temporal interval or that characterize a relationship between the financial institution and a corresponding customer during the current temporal interval. Further, one or more of the exemplary processes described herein provide, to the financial institution, a real-time indication of the likelihood of a future insolvency event involving one or more customers, which may inform a determination of not only an initial set of terms and conditions associated with a newly issued credit product, but also a subsequent modification of an existing set of terms and conditions associated with a previously issued credit product.

### A. Exemplary Processes for Adaptively Training Gradient-Boosted, Decision Tree Processes using Event Data in a Distributed Computing Environment

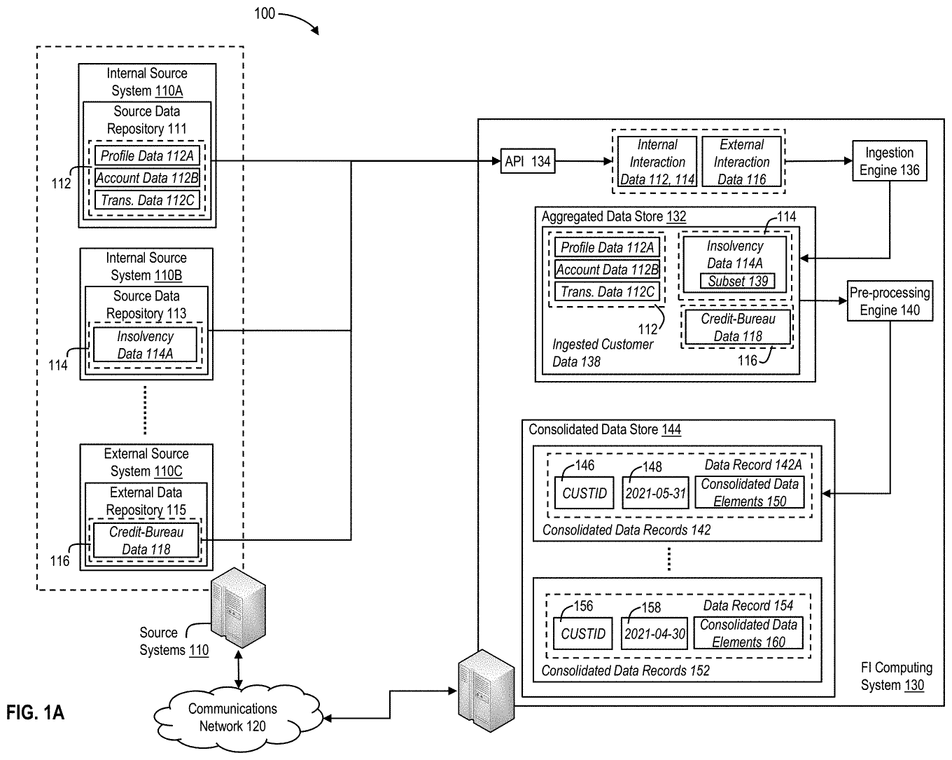

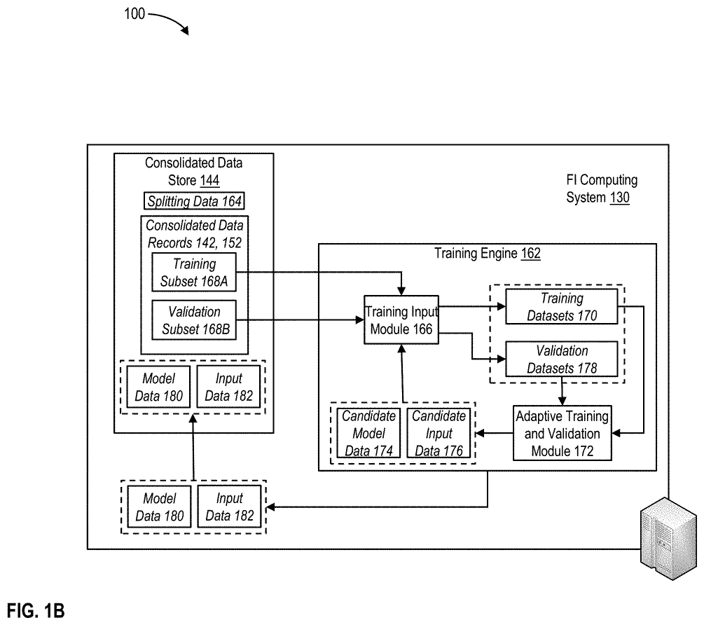

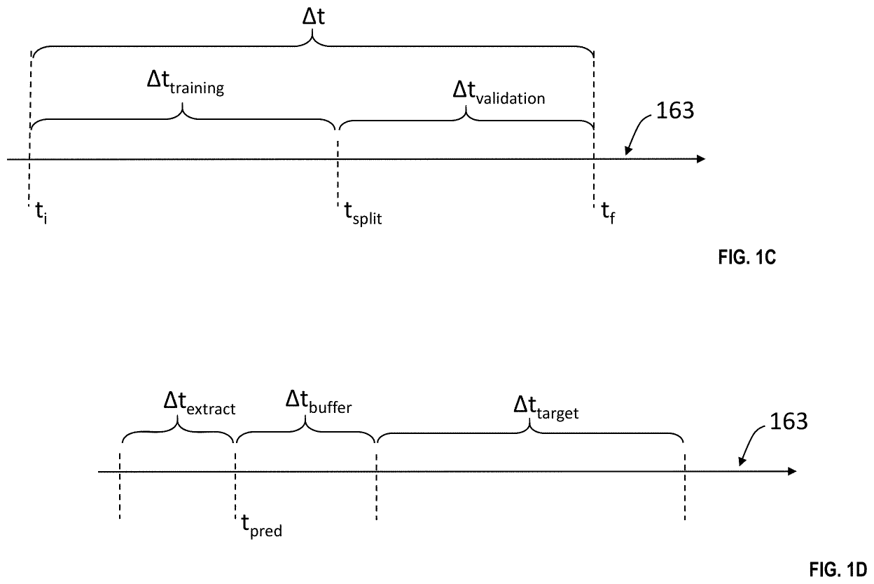

FIGS. 1A and 1B illustrate components of an exemplary computing environment 100, in accordance with some exemplary embodiments. For example, as illustrated in FIG. 1A, environment 100 may include one or more source systems 110, such as, but not limited to, internal source system 110A, internal source system 110B, and external source system 110C and a computing system associated with, or operated by, a financial institution, such as financial institution (FI) computing system 130. In some instances, each of source systems 110 (including internal source system 110A, internal source system 110B, and external source system 110C), and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 110 (including internal source system 110A, internal source system 110B, and external source system 110C) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including internal source system 110A, internal source system 1106, and external source system 110C) and FI computing system 130 may also include a communications interface, such as one or more wireless transceivers, coupled to the one or more processors for accommodating wired or wireless internet communication with other computing systems and devices operating within environment 100.

Further, in some instances, source systems 110 (including internal source system 110A, internal source system 1106, and external source system 110C) and FI computing system 130 may each be incorporated into a respective, discrete computing system. In additional, or alternate, instances, one or more of source systems 110 (including internal source system 110A and external source system 110C) and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™ Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, to ingest elements of data associated with the customers of the financial institution and insolvency events involving these customers, to preprocess the ingested data elements by filtering, aggregating, or downsampling certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to customer-specific input datasets and generate, in real time, elements of output data indicative of a likelihood of an occurrence of an insolvency event involving corresponding ones of the customers during a future temporal interval, such a twelve-month interval between three and fifteen months from a prediction date. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1A, each of source systems 110 may maintain, within corresponding tangible, non-transitory memories, a data repository that includes confidential data associated with the customers of the financial institution. For example, internal source system 110A may be associated with, or operated by, the financial institution, and may maintain, within the corresponding one or more tangible, non-transitory memories, a source data repository 111 that includes one or more elements of internal interaction data 112. In some instances, internal interaction data 112 may include data that identifies or characterizes one or more customers of the financial institution and interactions between these customers and the financial institution, and examples of the confidential data include, but are not limited to, customer profile data 112A, account data 112B, and/or transaction data 112C.

In some instances, customer profile data 112A may include a plurality of data records associated with, and characterizing, corresponding ones of the customers of the financial institution. By way of example, and for a particular customer of the financial institution, the data records of customer profile data 112A may include, but are not limited to, one or more unique customer identifiers (e.g., an alphanumeric character string, such as a login credential, a customer name, etc.), residence data (e.g., a street address, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution. Further, customer profile data 112A may also include, for the particular customer, multiple data records that include corresponding elements of temporal data (e.g., a time or date stamp, etc.), and the multiple data records may establish, for the particular customer, a temporal evolution in the customer residence or a temporal evolution in one or more of the demographic parameter values.

Account data 112B may also include a plurality of data records that identify and characterize one or more financial products or financial instruments issued by the financial institution to corresponding ones of the customers. For example, the data records of account data 112B may include, for each of the financial products issued to corresponding ones of the customers, one or more identifiers of the financial product or instrument (e.g., an account number, expiration data, card-security-code, etc.), one or more unique customer identifiers (e.g., an alphanumeric character string, such as a login credential, a customer name, etc.), and additional information characterizing a balance or current status of the financial product or instrument (e.g., payment due dates or amounts, delinquent accounts statuses, etc.).

Examples of these financial products or financial instruments may include, but are not limited to, one or more deposit accounts issued to corresponding ones of the customers (e.g., a savings account, a checking account, etc.), one or more brokerage or retirements accounts issued to corresponding ones of the customers by the financial institutions, and one or more secured credit products issued to corresponding ones of the customers by the financial institution (e.g., a home mortgage, a home-equity line-of-credit (HELOC), an auto loan, etc.). The financial products or financial instruments may also include one or more unsecured credit products issued to corresponding ones of the customers by the financial institution, and examples of these unsecured credit products may include, but are not limited to, a credit-card account, a personal loan, or an unsecured line-of-credit. Further, and in addition to specifying the one or more identifiers of the unsecured credit products and the additional information characterizing the balance or current status of the unsecured credit products, the data records of account data 112B may also identify, for each of the unsecured credit products, one or more terms and conditions that include, but are not limited to, an amount of credit extended to the corresponding customer, a repayment schedule, an interest rate, or a penalty imposed upon the corresponding customer by the financial institution in response to a determined violation of the terms or conditions.

Further, transaction data 112C may include data records that identify, and characterize one or more initiated, settled, or cleared transactions involving respective ones of the customers and corresponding ones of the issued financial products, including the unsecured credit products described herein. Examples of these transactions include, but are not limited to, purchase transactions, bill-payment transactions, electronic funds transfers, currency conversions, purchases of securities, derivatives, or other tradeable instruments, electronic funds transfer (EFT) transactions, peer-to-peer (P2P) transfers or transactions, or real-time payment (RTP) transactions. For instance, and for a particular transaction involving a corresponding customer and corresponding financial product, the data records of transaction data 112C may include, but are limited to, a customer identifier associated with the corresponding customer (e.g., the alphanumeric character string described herein, etc.), a counterparty identifier associated with a counterparty to the particular transaction (e.g., an alphanumeric character string, a counterparty name, etc.), an identifier of the corresponding financial product (e.g., a tokenized account number, expiration data, card-security-code, etc.), and values of one or more parameters of the particular transaction (e.g., a transaction amount, a transaction date, etc.).

Further, as illustrated in FIG. 1A, internal source system 1106 may also be associated with, or operated by, the financial institution, and may maintain, within the corresponding one or more tangible, non-transitory memories, a source data repository 113 that includes one or more additional elements of internal interaction data 114, which may include elements of insolvency data 114A. In some instances, insolvency data 114A may include one or more data records that identify and characterize occurrences of insolvency events involving customers of the financial institution and corresponding financial products or financial instruments issued by the financial institution. By way of example, each of the data records may associated with a corresponding occurrence of an insolvency event, and the each of the data records may include, for the corresponding occurrence of the insolvency event, a unique identifier of a customer associated with or involved in the corresponding occurrence of the insolvency event (e.g., an alphanumeric identifier or login credential, a customer name, etc.), a temporal data characterizing of the corresponding occurrence of the insolvency event (e.g., a time or date, etc.), information identifying one or more financial products or financial instruments associated with the corresponding occurrence of the insolvency event (e.g., a type of financial product or financial instrument, a portion of a tokenized account number), and additionally, or alternatively, information characterizing the corresponding occurrence of the insolvency event (e.g., an event type, such as a personal bankruptcy or proposed settlement, etc.).

By way of example, a customer of the financial institution may hold an unsecured credit product issued by the financial institution, such as a personal loan subject to corresponding repayment schedule, and may be unable to adhere to the repayment schedule and as such, may declare personal bankruptcy. Due to the personal bankruptcy (e.g., an occurrence of an insolvency event), the financial institution may be unable to recover at least a portion of the funds extended to, or utilized by, the customer through the unsecured personal loan. In some instances, insolvency data 114A may include a data record associated with the occurrence of the insolvency event (e.g., the personal bankruptcy) that includes, but is not limited to, an alphanumeric customer identifier (e.g., a login credential assigned by the financial institution), a temporal data characterizing the occurrence of the insolvency event (e.g., a date of the personal bankruptcy), information identifying the type of unsecured credit product involved in the occurrence of the insolvency event (e.g., the personal loan), and additional information identifying the type of insolvency event (e.g., the personal bankruptcy).

The disclosed embodiments are, however, not limited to these exemplary elements of customer profile data 112A, account data 112B, or transaction data 112C, or to these exemplary elements of insolvency data 114A. In other instances, the data records of internal interaction data 112 may include any additional or alternate elements of data that identify and characterize the customers of the financial institution and their relationships or interactions with the financial institution, financial products issued to these customers by the financial institution, and transactions involving corresponding ones of the customers and the issued financial products, and the data records of internal interaction data 114 may include any additional, or alternate, information identifying the characterizing the occurrences of the insolvency events, and the involved customers and financial products. Further, although stored in FIG. 1A within data repositories maintained by internal source systems 110A and 1106, the exemplary elements of customer profile data 112A, account data 1126, and transaction data 112C, and the exemplary elements of insolvency data 114A, may be maintained by any additional or alternate computing system associated with the financial institution, including, but not limited to, within one or more tangible, non-transitory memories of FI computing system 130.

External source system 110C may be associated with, or operated by, one or more judicial, regulatory, governmental, or reporting entities external to, and unrelated to, the financial institution, and external source system 110C may maintain, within the corresponding one or more tangible, non-transitory memories, a source data repository 115 that includes one or more elements of external interaction data 116. In some instances, external source system 110C may be associated with, or operated by, a reporting entity, such as a credit bureau, and external interaction data 116 may include data records that specify elements of credit-bureau data 118 associated with one or more customers of the financial institution. In some instances, the elements of credit-bureau data 118 for a particular one of the customers of the financial institution may include, but are not limited to, a unique identifier of the particular customer (e.g., an alphanumeric identifier or login credential, a customer name, etc.), information identifying one or more financial products currently or previously held by the particular customer (e.g., one or more of the unsecured credit products described herein, financial products issued by other financial institutions), information identifying a history of payments associated with these financial products, information identifying negative events associated with the particular customer (e.g., missed payments, collections, repossessions, etc.), and information identifying one or more credit inquiries involving the particular customer (e.g., inquiries by the financial institution, other financial institutions or business entities, etc.). The disclosed embodiments are, however, not limited to these exemplary elements of external interaction data 116, and in other instances, external interaction data 116 may include any additional or alternate elements of data associated with the customer and generated by the judicial, regulatory, governmental, or regulatory entities described herein, such as additional, or alternate, elements of credit-bureau data.

In some instances, FI computing system 130 may perform operations that establish and maintain one or more centralized data repositories within a corresponding ones of the tangible, non-transitory memories. For example, as illustrated in FIG. 1A, FI computing system 130 may establish an aggregated data store 132, which maintains, among other things, elements of the customer profile, account, transaction, insolvency, and credit-bureau data associated with one or more of the customers of the financial institution, which may be ingested by FI computing system 130 (e.g., from one or more of source systems 110) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 110, including internal source system 110A, internal source system 1106, and external source system 110C, across network 120, and may perform operations that access and obtain all, or a selected portion, of the elements of customer profile, account, transaction, insolvency, and/or reporting data maintained by corresponding ones of source systems 110. As illustrated in FIG. 1A, internal source system 110A may perform operations that obtain all, or a selected portion, of internal interaction data 112, including the data records of customer profile data 112A, account data 112B, and transaction data 112C, from source data repository 111, and transmit the obtained portions of internal interaction data 112 across network 120 to FI computing system 130. Further, internal source system 1106 may also perform operations that obtain all, or a selected portion, of internal interaction data 114, including the data records of insolvency data 114A, from source data repository 113, and transmit the obtained portions of internal interaction data 114 across network 120 to FI computing system 130. Additionally, in some instances, external source system 110C may also perform operations that obtain all, or a selected portion, of external interaction data 116, including the data records of credit-bureau data 118, from source data repository 115, and transmit the obtained portions of external interaction data 116 across network 120 to FI computing system 130.

In some instances, and prior to transmission across network 120 to FI computing system 130, internal source system 110A, internal source system 1106, and external source system 110C may encrypt respective portions of internal interaction data 112 (including the data records of customer profile data 112A, account data 112B, and transaction data 112C), internal interaction data 114 (including the data records of insolvency data 114A), and external interaction data 116 (including the data records of credit-bureau data 118) using a corresponding encryption key, such as, but not limited to, a corresponding public cryptographic key associated with FI computing system 130. Further, although not illustrated in FIG. 1A, each additional, or alternate, one of source systems 110 may perform any of the exemplary processes described herein to obtain, encrypt, and transmit additional, or alternate, portions of the customer profile, account, transaction, insolvency, or credit-bureau data maintained locally maintained by source systems 110 across network 120 to FI computing system 130.

A programmatic interface established and maintained by FI computing system 130, such as application programming interface (API) 134, may receive the portions of internal interaction data 112 (including the data records of customer profile data 112A, account data 1126, and transaction data 112C) from internal source system 110A, the portions of internal interaction data 114 (including the data records of insolvency data 114A) from internal source system 1106, and external interaction data 116 (including the data records of credit-bureau data 118) from external source system 110C. As illustrated in FIG. 1A, API 134 may route the portions of internal interaction data 112 (including the data records of customer profile data 112A, account data 112B, and transaction data 112C), internal interaction data 114 (including the data records of insolvency data 114A), and external interaction data 116 (including the data records of credit-bureau data 118) to a data ingestion engine 136 executed by the one or more processors of FI computing system 130. As described herein, the portions of internal interaction data 112 and 114 and external customer data 116 (and the additional, or alternate, portions of the customer profile, account, transaction, or reporting data) may be encrypted, and executed data ingestion engine 136 may perform operations that decrypt each of the encrypted portions of internal interaction data 112 and 114 and external interaction data 116 (and the additional, or alternate, portions of the customer profile, account, transaction, or reporting data) using a corresponding decryption key, e.g., a private cryptographic key associated with FI computing system 130.

Executed data ingestion engine 136 may also perform operations that store the portions of internal interaction data 112 (including the data records of customer profile data 112A, account data 112B, and transaction data 112C), internal interaction data 114 (including the data records of insolvency data 114A), and external interaction data 116 (including the data records of credit-bureau data 118) within aggregated data store 132, e.g., as ingested customer data 138. As illustrated in FIG. 1A, a pre-processing engine 140 executed by the one or more processors of FI computing system 130 may access ingested customer data 138, and perform any of the exemplary processes described herein to access elements of ingested customer data 138 (e.g., the data records of customer profile data 112A, account data 112B, transaction data 112C. insolvency data 114A, and/or credit-bureau data 118). In some instances, executed data preprocessing perform any of the exemplary data-processing operations described herein to parse the accessed elements of ingested customer data 138, to selectively aggregate, filter, and process the accessed elements of elements of ingested customer data 138, and to generate consolidated data records 142 that characterize corresponding ones of the customers, their interactions with the financial institution and with other financial institutions, and any associated insolvency events during a corresponding temporal interval associated with the ingestion of internal interaction data 112 and 114 and external interaction data 116 by executed data ingestion engine 136.

By way of example, executed pre-processing engine 140 may access the data records of insolvency data 114A (e.g., as maintained within ingested customer data 138), and may perform operations that filter the data records of insolvency data 114A in accordance with one or more customer- or account-specific criteria, and that identify and extract from insolvency data 114A, a subset 139 of the data records associated with occurrences of insolvency events that are consistent one or more customer- or account-specific criteria. The one or more customer- or account-specific criteria may, for example, specify that executed pre-processing engine 140 identify, and extract from insolvency data 114A, one or more of the data records that characterize occurrences of insolvency events involving, or implicating, corresponding unsecured credit products issued by the financial institution, such as, but not limited to, the credit-card accounts, personal loans, or unsecured line-of-credit described herein. In other examples, the one or more customer- or account-specific criteria may specify that executed pre-processing engine 140 identify, and extract from insolvency data 114A, one or more of a subset of the data records that characterize occurrences of insolvency events involving personal-banking customers of the financial institution or financial products held by these personal-banking customers (e.g., as opposed to business-banking customers, or financial products held by business customers). The disclosed embodiments are, however, not limited to these exemplary customer- or account-specific criteria, and in other instances, executed pre-processing engine 140 may filter the data records of insolvency data 114A in accordance with any additional, or alternative, customer-, account-, or event-specific criteria appropriate to the occurrences of the insolvency events or the associated customers or accounts.

Further, in some examples, executed pre-processing engine 140 may access the data records of profile data 112A, account data 112B, transaction data 112C, and/or credit-bureau data 118 (e.g., as maintained within ingested customer data 138), and may access the newly extracted subset 139 of the data records of insolvency data 114A. As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign, to each of the accessed data records, a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which FI computing system 130 ingests the elements of internal interaction data 112, insolvency data 114A, and external interaction data 116 from corresponding ones of source systems 110. For example, executed data ingestion engine 136 may receive elements of confidential customer data from corresponding ones of source systems 110 on a monthly basis (e.g., on the final day of the month), and in particular, may receive and store the elements of internal interaction data 112, internal interaction data 114, and external interaction data 116 from corresponding ones of source systems 110 on May 31, 2021. In some instances, executed pre-processing engine 140 may generate a temporal identifier associated with the regular, monthly ingestion of internal interaction data 112, internal interaction data 114, and external interaction data 116 on May 31, 2021 (e.g., “2021-05-31”), and may augment the accessed data records of profile data 112A, account data 1126, transaction data 112C, subset 139, and/or credit-bureau data 118 to include the generated temporal identifier. The disclosed embodiments are, however, not limited to temporal identifiers reflective of a regular, monthly ingestion of internal interaction data 112, internal interaction data 114, and external interaction data 116 by FI computing system 130, and in other instances, executed pre-processing engine 140 may augment the accessed data records to include temporal identifiers reflective of any additional, or alternative, temporal interval during which FI computing system 130 ingests the elements of internal interaction data 112, internal interaction data 114, and external interaction data 116.

In some instances, executed pre-processing engine 140 may perform further operations that, for a particular customer of the financial institution during the temporal interval (e.g., represented by a pair of the customer and temporal identifiers described herein), obtain one or more data records of profile data 112A, account data 112B, transaction data 112C, insolvency subset 139, and credit-bureau data 118 that include the pair of customer and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular customer of the financial institution across the temporal intervals. By way of example, executed pre-processing engine 140 may consolidate the obtained data records, which include the pair of customer and temporal identifiers, through an invocation of an appropriate Java-based SQL “join” command (e.g., an appropriate “inner” or “outer” join command, etc.). Further, executed pre-processing engine 140 may perform any of the exemplary processes described herein to generate another one of consolidated data records 142 for each additional, or alternate, customer of the financial institution during the temporal interval (e.g., as represented by a corresponding customer identifier and the temporal interval).

Executed pre-processing engine 140 may perform operations that store each of consolidated data records 142 within one or more tangible, non-transitory memories of FI computing system 130, such as consolidated data store 144. Consolidated data store 144 may, for instance, correspond to a data lake, a data warehouse, or another centralized repository established and maintained, respectively, by the distributed components of FI computing system 130, e.g., through a Hadoop™ distributed file system (HDFS). In some instances, and as described herein, consolidated data records 142 may include a plurality of discrete data records, each of these discrete data records may be associated with, and may maintain data characterizing, a corresponding one of the customers of the financial institution during the corresponding temporal interval (e.g., a month-long interval extending from May 1, 2021, to May 31, 2021). For example, and for a particular customer of the financial institution, discrete data record 142A of consolidated data records 142 may include a customer identifier 146 of the particular customer (e.g., an alphanumeric character string “CUSTID”), a temporal identifier 148 of the corresponding temporal interval (e.g., a numerical string “2021-05-31”), and consolidated elements 150 of customer profile, account, transaction, insolvency, or credit-bureau data that characterize the particular customer during the corresponding temporal interval (e.g., as consolidated from the data records of profile data 112A, account data 112B, transaction data 112C, insolvency subset 139, and/or credit-bureau data 118 ingested by FI computing system 130 on May 31, 2021).

Further, in some instances, consolidated data store 144 may maintain each of consolidated data records 142, which characterize corresponding ones of the customers, their interactions with the financial institution and with other financial institutions, and any associated insolvency events during the temporal interval, in conjunction with additional consolidated data records 152. Executed pre-processing engine 140 may perform any of the exemplary processes described herein to generate each of the additional consolidated data records 152, including based on elements of profile, account, transaction, insolvency, and credit-bureau data ingested from source systems 110 during the corresponding prior temporal intervals.

Further, and as described herein, each of additional consolidated data records 152 may also include a plurality of discrete data records that are associated with and characterize a particular one of the customers of the financial institution during a corresponding one of the prior temporal intervals. For example, as illustrated in FIG. 1A, additional consolidated data records 152 may include one or more discrete data records, such as discrete data record 154, associated with a prior temporal interval extending from Apr. 1, 2021, to Apr. 30, 2021. For the particular customer, discrete data record 154 may include a customer identifier 156 of the particular customer (e.g., an alphanumeric character string “CUSTID”), a temporal identifier 158 of the prior temporal interval (e.g., a numerical string “2021-04-30”), and consolidated elements 160 of customer profile, account, transaction, insolvency, or credit-bureau data that characterize the particular customer during the prior temporal interval extending from Apr. 1, 2021, to Apr. 30, 2021 (e.g., as consolidated from the data records ingested by FI computing system 130 on Apr. 30, 2021).

The disclosed embodiments are, however, not limited to the exemplary consolidated data records described herein, or to the exemplary temporal intervals described herein. In other examples, FI computing system 130 may generate, and the consolidated data store 144 may maintain any additional or alternate number of discrete sets of consolidated data records, having any additional or alternate composition, that would be appropriate to the elements of customer profile, account, transaction, insolvency, or credit-bureau data ingested by FI computing system 130 at the predetermined intervals described herein. Further, in some examples, FI computing system 130 may ingest elements of customer profile, account, transaction, insolvency, or credit-bureau data from source systems 110 at any additional, or alternate, fixed or variable temporal interval that would be appropriate to the ingested data or to the adaptive training of the machine learning or artificial intelligence processes described herein.

In some instances, FI computing system 130 may perform any of the exemplary operations described herein to adaptively train a machine-learning or artificial-intelligence process to predict a likelihood of an occurrence of an insolvency event involving a customer during a future temporal interval using training datasets associated with a first prior temporal interval (e.g., a “training” interval), and using validation datasets associated with a second, and distinct, prior temporal interval (e.g., an out-of-time “validation” interval). As described herein, the machine-learning or artificial-intelligence process may include an ensemble or decision-tree process, such as a gradient-boosted decision-tree process (e.g., the XGBoost model), and the training and validation datasets may include, but are not limited to, values of adaptively selected features obtained, extracted, or derived from the consolidated data records maintained within consolidated data store 144, e.g., from data elements maintained within the discrete data records of consolidated data records 142 or the additional consolidated data records 152.

For example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within consolidated data store 144.

Referring to FIG. 1B, a training engine 162 executed by the one or more processors of FI computing system 130 may access the consolidated data records maintained within consolidated data store 144, such as, but not limited to, the discrete data records of consolidated data records 142 or additional consolidated data records 152. As described herein, each of the consolidated data records, such as discrete data record 142A of consolidated data records 142 or discrete data record 154 of additional consolidated data records 152, may include a customer identifier of a corresponding one of the customers of the financial institution (e.g., customer identifiers 146 and 156 of FIG. 1A) and a temporal identifier that associates the consolidated data record with a corresponding temporal interval (e.g., temporal identifiers 148 and 158 of FIG. 1A). Further, as described herein, each of the accessed consolidated data records may include consolidated elements of customer profile, account, transaction, insolvency, or credit-bureau data that characterize the corresponding one of the customers during the corresponding temporal interval (e.g., consolidated elements 150 and 160 of FIG. 1A).

In some instances, executed training engine 162 may parse the accessed consolidated data records, and based on corresponding ones of the temporal identifiers, determine that the consolidated elements of customer profile, account, transaction, insolvency, or credit-bureau data characterize the corresponding customers across a range of prior temporal intervals. Further, executed training engine 162 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1C, the range of prior temporal intervals (e.g., shown generally as At along timeline 163 of FIG. 1C) may be bounded by, and established by, temporal boundaries tᵢ and t_{f}. Further, the decomposed first subset of the prior temporal intervals (e.g., shown generally as training interval Δt_{training} along timeline 163 of FIG. 1C) may be bounded by temporal boundary tᵢ and a corresponding splitting point tₛₚₗᵢₜ along timeline 163, and the decomposed second subset of the prior temporal intervals (e.g., shown generally as validation interval Δt_{validation} along timeline 163 of FIG. 1C) may be bounded by splitting point tₛₚₗᵢₜ and temporal boundary t_{f}.

Referring back to FIG. 1B, executed training engine 162 may generate elements of splitting data 164 that identify and characterize the determined temporal boundaries of the consolidated data records maintained within consolidated data store 144 (e.g., temporal boundaries tᵢ and t_{f}) and the range of prior temporal intervals established by the determined temporal boundaries Further, the elements of splitting data 164 may also identify and characterize the splitting point (e.g., the splitting point tₛₚₗᵢₜ described herein), the first subset of the prior temporal intervals (e.g., the training interval Δt_{training} and corresponding boundaries described herein), and the second, and subsequent subset of the prior temporal intervals (e.g., the validation interval Δt_{validation} and corresponding boundaries described herein). As illustrated in FIG. 1B, executed training engine 162 may store the elements of splitting data 164 within the one or more tangible, non-transitory memories of FI computing system 130, e.g., within consolidated data store 144.

As described herein, each of the prior temporal intervals may correspond to a one-month interval, and executed training engine 162 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. For example, the first predetermined percentage may correspond to seventy percent of the consolidated data records, and the second predetermined percentage may corresponding to thirty percent of the consolidated data records, although in other examples, executed training engine 162 may compute one or both of the first and second predetermined percentages, and establish the decomposition point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 166 of executed training engine 162 may perform operations that access the consolidated data records maintained within consolidated data store 144. As described herein, each of the accessed data records (e.g., the discrete data records within consolidated data records 142 or additional consolidated data records 152) characterize a customer of the financial institution (e.g., identified by a corresponding customer identifier), the interactions of the customer with the financial institution and with other financial institutions, and any associated insolvency events involving the customer during a particular temporal interval (e.g., associated with a corresponding temporal identifier). In some instances, and based on portions of splitting data 164, executed training input module 166 may perform operations that parse the consolidated data records and determine: (i) a first subset 168A of these consolidated data records are associated with the training interval Δt_{training} and may be appropriate to training adaptively the gradient-boosted decision model during the training interval; and a (ii) second subset 168B of these consolidated data records are associated with the validation interval Δt_{validation} and may be appropriate to validating the adaptively trained gradient-boosted decision model during the validation interval.

As described herein, FI computing system 130 may perform operations that adaptively train a machine-learning or artificial-intelligence process (e.g., the gradient-boosted, decision-tree process described herein) to predict, during a current temporal interval, a likelihood of an occurrence of an insolvency event involving a customer during a future temporal interval using training datasets associated with the training interval, and using validation datasets associated with the validation interval. For example, and as illustrated in FIG. 1D, the current temporal interval may be characterized by a temporal prediction point t_{pred} along timeline 163, and the executed training engine 162 may perform any of the exemplary processes described herein to train adaptively machine-learning or artificial-intelligence process (e.g., the gradient-boosted, decision-tree process described herein) to predict the likelihood of occurrences of insolvency events future a future, target temporal interval Δt_{target} based on input datasets associated with a corresponding prior extraction interval Δt_{extract}. Further, as illustrated in FIG. 1D, the target temporal interval Δt_{target} may be separated temporally from the temporal prediction point t_{pred} by a corresponding buffer interval Δt_{buffer}.

By way of example, the target temporal interval Δt_{target} may be characterized by a predetermined duration, such as, but not limited to, twelve months, and the prior extraction interval Δt_{extract} may be characterized by a corresponding, predetermined duration, such as, but not limited to, one month. Further, in some examples, the buffer interval Δt_{buffer} may also be associated with a predetermined duration, such as, but not limited to, three months, and the predetermined duration of buffer interval 66 t_{buffer} may established by FI computing system 130 to separate temporally the customers' prior interactions with the financial institution (and with other financial institutions) and insolvency events, the future target temporal interval Δt_{target}.

Referring back to FIG. 1B, executed training input module 166 may perform operations that access the consolidated data records maintained within consolidated data store 144, and parse each of the consolidated data records to obtain a corresponding customer identifier (e.g., which associates with the consolidated data record with a corresponding one of the customers of the financial institution) and a corresponding temporal identifier (e.g., which associated the consolidated data record with a corresponding temporal interval). For example, and based on the obtained customer and temporal identifiers, executed training input module 166 may generate sets of segmented data records associated with corresponding ones of the customer identifiers (e.g., customer-specific sets of segmented data records), and within each set of segmented data records, executed training input module 166 may order the consolidated data records sequentially in accordance with the obtained temporal interval. Through these exemplary processes, executed training input module 166 may generate sets of customer-specific, sequentially ordered data records (e.g., data tables), which executed training input module 166 may maintain locally within the consolidated data store 144 (not illustrated in FIG. 1B).

In some instances, executed training input module 166 may perform operations that augment the sequentially ordered data records within each of the customer-specific sets to include additional information characterizing a ground truth associated with the corresponding customer and temporal interval (as established by the corresponding pair of customer and temporal identifiers). For example, and for a particular one of the sequentially ordered data record, such as discrete data record 142A of consolidated data records 142, executed training input module 166 may obtain customer identifier 146 (e.g., “CUSTID”), which identifies the corresponding customer, and temporal identifier 148, which indicates data record 142A is associated with May 31, 2021. Based on customer identifier 146 and temporal identifier 148, executed training input module 166 may access insolvency data 114A (e.g., as maintained within consolidated data store 144), and determine whether the corresponding customer experienced an insolvency data within the target interval Δt_{target}, which may be separated from the temporal interval associated with the data record 142A by the corresponding buffer interval Δt_{buffer}, as described herein. Executed training input module 166 may perform operations that modify data record 142A by appending an element of ground-truth data indicative of the presence or absence of the insolvency event within the target interval Δt_{target} to consolidated data elements 150. Executed training input module 166 may also perform any of the exemplary processes described herein to generate and append an appropriate element of ground-truth data to each additional, or alternate, one of the sequentially ordered data records within each of the customer-specific sets maintained within consolidated data store 144.

Executed training input module 166 may also perform operations that partition the customer-specific sets of sequentially ordered data records into subsets suitable for training adaptively the gradient-boosted, decision-tree process (e.g., which may be maintained in first subset 168A of consolidated data records within consolidated data store 144) and for validating the adaptively trained, gradient-boosted, decision-tree process (e.g., which may be maintained in second subset 168B of consolidated data records within consolidated data store 144). By way of example, executed training input module 166 may access splitting data 164, and establish the temporal boundaries for the training interval Δt_{training} (e.g., temporal boundary tᵢ and splitting point tₛₚₗᵢₜ) and the validation interval Δt_{training} (e.g., splitting point tₛₚₗᵢₜ and temporal boundary t_{f}). Further, executed training input module 166 may also parse each of the sequentially ordered data records of the customer-specific sets, access the corresponding temporal identifier, and determine the temporal interval associated with the each of sequentially ordered data records.

If, for example, executed training input module 166 were to determine that the temporal interval associated with a corresponding one of the sequentially ordered data records is disposed within the temporal boundaries for the training interval Δt_{training}, executed training input module 166 may determine that the corresponding data record may be suitable for training, and may perform operations that include the corresponding data record within a portion of the first subset 168A (e.g., that store the corresponding data record within a portion of consolidated data store 144 associated with first subset 168A). Alternatively, if executed training input module 166 were to determine that the temporal interval associated with a corresponding one of the sequentially ordered data records is disposed within the temporal boundaries for the validation interval Δt_{validation}, executed training input module 166 may determine that the corresponding data record may be suitable for validation, and may perform operations that include the corresponding data record within a portion of the second subset 168B (e.g., that store the corresponding data record within a portion of consolidated data store 144 associated with second subset 168B). Executed training input module 166 may perform any of the exemplary processes described herein to determine the suitability of each additional, or alternate, one of the sequentially ordered data records of the customer-specific sets for adaptive training, or alternatively, validation, of the gradient-boosted, decision-tree process.

In some instances, executed training input module 166 may also perform operations that filter the consolidated data records of first subset 168A and second subset 168B in accordance with one or more filtration criteria. By way of example, the one or more filtration criteria may cause executed training input module 166 to perform operations that exclude, from first subset 168A and second subset 168B, a consolidated data record of any customer associated with an occurrence of an insolvency event during, or prior to, the temporal interval associated with the corresponding temporal identifier. Further, in some instances, the consolidated data records within first subset 168A and second subset 168B may represent an imbalanced data set in which the actual instances of insolvency within the target interval Δt_{target} are outnumbered disproportionately by actual instances of solvency within the target interval Δt_{target} (e.g., as established by the elements of ground-truth data appended for the consolidated data records, as described herein). Based on the imbalanced character of first subset 168A and second subset 168B, executed training input module 166 may perform operations that downsample the consolidated data records within first subset 168A and second subset 168B that are associated with the actual instances of solvency (e.g., as established by the appended elements of ground-truth data), and the downsampled data records maintained within each first subset 168A and second subset 168B may represent balanced data sets characterized by a more proportionate balance between the actual instances of solvency and insolvency.

Referring back to FIG. 1B, executed training input module 166 may perform operations that generate a plurality of training datasets 170 based on elements of data obtained, extracted, or derived from all or a selected portion of first subset 168A of the consolidated data records. In some instances, the plurality of training datasets 170 may, when provisioned to an input layer of the gradient-boosted decision-tree process described herein, enable executed training engine 162 to train adaptively the gradient-boosted decision-tree process to predict, during a current temporal interval, a likelihood of occurrences of insolvency events involving customers of the financial institution during a future temporal interval.

By way of example, each of the plurality of training datasets 170 may be associated with a corresponding one of the customers of the financial institution and a corresponding temporal interval, and may include, among other things a customer identifier associated with that corresponding customer and a temporal identifier representative of the corresponding temporal interval, as described herein. Each of the plurality of training datasets 170 may also include elements of data (e.g., feature values) that characterize the corresponding one of the customers, the corresponding customer's interaction with the financial institution or with other financial institution, and/or an occurrence (or lack thereof) of insolvency events involving the corresponding customer during a temporal interval disposed prior to the corresponding temporal interval, e.g., the extraction interval Δt_{extract} described herein. Further, each of training datasets 170 may also include an element of ground-truth data indicative of the presence or absence of an insolvency event associated with a corresponding one of the customers within a twelve-month period subsequent to the corresponding temporal interval (e.g., as specified by the corresponding temporal identifier).

In some instances, executed training input module 166 may perform operations that identify, and obtain or extract, one or more of the features values from the consolidated data records maintained within first subset 168A and associated with the corresponding one of the customers. The obtained or extracted feature values may, for example, include elements of the customer profile, account, transaction, insolvency, or credit-bureau data described herein (e.g., which may populate the consolidated data records maintained within first subset 168A), and examples of these obtained or extracted feature values may include, but are not limited to, data identifying one or more types of financial products held by the customer corresponding one of the customers, a total balance associated with one or more credit instruments held by the corresponding one of the customers, or a number of credit inquiries involving the corresponding one of the customers. These disclosed embodiments are, however, not limited to these examples of obtained or extracted feature values, and in other instances, training datasets 170 may include any additional or alternate element of data extracted or obtained from the consolidated data records of first subset 168A, associated with corresponding one of the customers, and associated with the extraction interval Δt_{extract} described herein.

Further, in some instances, executed training input module 166 may perform operations that compute, determine, or derive one or more of the features values based on elements of data extracted or obtained from the consolidated data records maintained within first subset 168A. Examples of these computed, determined, or derived feature values may include, but are not limited to, time-average values of payments associated with one or more financial products held by corresponding ones of the customer, time-average balances associated with these financial products, sums of balances held in various demand or deposit accounts by corresponding ones of the customers, total numbers of past-due balances or delinquencies associated with corresponding ones of the customers. These disclosed embodiments are, however, not limited to these examples of computed, determined, or derived feature values, and in other instances, training datasets 170 may include any additional or alternate featured computed, determine, or derived from data extracted or obtained from the consolidated data records of first subset 168A, associated with corresponding one of the customers, and associated with the extraction interval Δt_{extract} described herein.

Executed training input module 166 may provide training datasets 170 as an input to an adaptive training and validation module 172 of executed training engine 162. In some instances, and upon execution by the one or more processors of FI computing system 130, adaptive training and validation module 172 may perform operations that establish a plurality of nodes and a plurality of decision trees for the gradient-boosted, decision-tree process, with may ingest and process the elements of training data (e.g., the customer identifiers, the temporal identifiers, the feature values, etc.) maintained within each of the plurality of training datasets 170. Further, and based on the execution of adaptive training and validation module 172, and on the ingestion of each of training datasets 170 by the established nodes of the gradient-boosted, decision-tree process, FI computing system 130 may perform operations that adaptively train the gradient-boosted, decision-tree process against the elements of training data included within each of training datasets 170.

In some examples, the distributed components of FI computing system 130 may execute adaptive training and validation module 172, and may perform any of the exemplary processes described herein in parallel to adaptively train the gradient-boosted, decision-tree process against the elements of training data included within each of training datasets 170. The parallel implementation of adaptive training and validation module 172 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

Through the performance of these adaptive training processes, executed adaptive training and validation module 172 may perform operations that compute one or more candidate model parameters that characterize the adaptively trained, gradient-boosted, decision-tree process, and package the candidate model parameters into corresponding portions of candidate model data 174. In some instances, the candidate model parameters included within candidate model data 174 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, executed adaptive training and validation module 172 may also generate candidate input data 176, which specifies a candidate composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 1B, executed adaptive training and validation module 172 may provide candidate model data 174 and candidate input data 176 as inputs to executed training input module 166 of training engine 162, which may perform any of them exemplary processes described herein to generate a plurality of validation datasets 178 having compositions consistent with candidate input data 176. As described herein, the plurality of validation datasets 178 may, when provisioned to, and ingested by, the nodes of the decision trees of the adaptively trained, gradient-boosted, decision-tree process, enable executed training engine 162 to validate the predictive capability and accuracy of the adaptively trained, gradient-boosted, decision-tree process, for example, based on elements of ground truth data incorporated within the validation datasets 178, or based on one or more computed metrics, such as, but not limited to, computed precision values, computed recall values, and computed area under curve (AUC) for receiver operating characteristic (ROC) curves or precision-recall (PR) curves.

By way of example, executed training input module 166 may parse candidate input data 176 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 166 and packaged into corresponding potions of training datasets 170, as described herein.

Further, in some examples, each of the plurality of validation datasets 178 may be associated with a corresponding one of the customers of the financial institution, and with a corresponding temporal interval within the validation interval Δt_{validation}, and executed training input module 166 may access the consolidated data records maintained within second subset 168B of consolidated data store 144, and may perform operations that extract, from an initial one of the consolidated data records, a customer identifier (which identifies a corresponding one of the customers of the financial institution associated with the initial one of the consolidated data records) and a temporal identifier (which identifies a temporal interval associated with the initial one of the consolidated data records). Executed training input module 166 may package the extracted customer identifier and temporal identifier into portions of a corresponding one of validation datasets 178, e.g., in accordance with candidate input data 176.

Executed training input module 166 may perform operations that access one or more additional ones of the consolidated data records that are associated with the corresponding one of the customers (e.g., that include the customer identifier) and as associated with a temporal interval (e.g., based on corresponding temporal identifiers) disposed prior to the corresponding temporal interval, e.g., within the extraction interval Δt_{extract} described herein. Based on portions of candidate input data 176, executed training input module 166 may identify, and obtain or extract one or more of the feature values of the validation datasets from within the additional ones of the consolidated data records within second subset 168B. Further, in some examples, and based on portions of candidate input data 176, executed training input module 166 may perform operations that compute, determine, or derive one or more of the features values based on elements of data extracted or obtained from further ones of the consolidated data records within second subset 168B. Executed training input module 166 may package each of the obtained, extracted, computed, determined, or derived feature values into corresponding positions within the initial one of validation datasets 178, e.g., in accordance with the candidate sequence or position specified within candidate input data 176.

Further, executed training input module 166 may package, into an appropriate position within portion of the corresponding one of validation datasets 178, an element of ground-truth data indicative of the presence or absence of an insolvency event associated with the corresponding one of the customers within a twelve-month period subsequent to the corresponding temporal interval. For example, executed training input module 166 may parse the initial one of the consolidated data records, extract the element of ground-truth data, and package the extracted element of ground-truth data into the appropriate position within the corresponding one of validation datasets 178, e.g., in accordance with the candidate sequence or position specified within candidate input data 176.

In some instances, executed training input module 166 may perform any of the exemplary processes described herein to generate additional, or alternate, ones of validation datasets 178 based on the elements of data maintained within the consolidated data records of second subset 168B. For example, each of the additional, or alternate, ones of validation datasets 178 may associated with a corresponding, and distinct, pair of customer and temporal identifiers, and as such, corresponding customers of the financial institution and corresponding temporal intervals within validation interval Δt_{validation}. Further, executed training input module 166 may perform any of the exemplary processes described herein to generate an additional, or alternate, ones of validation datasets 178 associated with each unique pair of customer and temporal identifiers maintained within the consolidated data records of second subset 168B, and in other instances a number of discrete validation datasets within validation datasets 178 may be predetermined or specified within candidate input data 176.

Referring back to FIG. 1B, executed training input module 166 may provide the plurality of validation datasets 178 as inputs to executed adaptive training and validation module 172. In some examples, executed adaptive training and validation module 172 may perform operations that apply the adaptively trained, gradient-boosted, decision-tree process to respective ones of validation datasets 178 (e.g., based on the candidate model parameters within candidate model data 174, as described herein), and that generate elements of output data based on the application of the adaptively trained, gradient-boosted, decision-tree process to corresponding ones of validation datasets 178.

As described herein, each of the each of elements of output data may be generated through the application of the adaptively trained, gradient-boosted, decision-tree process to a corresponding one of validation datasets 178. which may include, among other things, a customer identifier (e.g., identifying a corresponding customer of the financial institution), a temporal identifier (e.g., identifying a corresponding temporal interval), and an element of ground-truth data, which indicates whether the corresponding customer is involved in an actual insolvency event during a future temporal interval, e.g., the target interval Δt_{target} separated from the corresponding temporal interval by buffer interval Δt_{buffer}. Further, as described herein, each of elements of output data may be representative of a predicted likelihood of an occurrence of an insolvency event involving, or associated with, the corresponding customer during the target interval Δt_{target}, and in some instances, the predicted likelihood may be represented by a numerical score ranging from zero (e.g., indicative of a minimal predicted likelihood) to unity (e.g., indicative of a maximum predicted likelihood).

Executed adaptive training and validation module 172 may perform operations that compute a value of one or more metrics that characterize a predictive capability, and an accuracy, of the adaptively trained, gradient-boosted, decision-tree process based on the generated elements of output data and corresponding ones of validation datasets 178. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, and additional, or alternatively, computed value of an AUC for a receiver operating characteristic (ROC) curve associated with the adaptively trained, gradient-boosted, decision-tree process. The disclosed embodiments are, however, not limited to these exemplary computed metric values, and in other instances, executed adaptive training and validation module 172 may compute a value of any additional, or alternate, metric appropriate to validation datasets 178, the elements of ground-truth data, or the adaptively trained, gradient-boosted, decision-tree process

In some examples, executed adaptive training and validation module 172 may also perform operations that determine whether all, or a selected portion of, the computed metric values satisfy one or more threshold conditions for a deployment of the adaptively trained, gradient-boosted, decision-tree process and a real-time application to elements of customer profile, account, transaction, insolvency, or credit-bureau data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values. In some examples, executed adaptive training and validation module 172 that establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, executed adaptive training and validation module 172 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of customer profile, account, transaction, insolvency, or credit-bureau data described herein. Executed adaptive training and validation module 172 may perform operations (not illustrated in FIG. 1B) that transmit data indicative of the established inaccuracy to executed training input module 166, which may perform any of the exemplary processes described herein to generate one or more additional training datasets and to provision those additional encrypted training datasets to executed adaptive training and validation module 172. In some instances, executed adaptive training and validation module 172 may receive the additional training datasets, and may perform any of the exemplary processes described herein to train further the gradient-boosted, decision-tree process against the elements of training data included within each of the additional training datasets.

Alternatively, if executed adaptive training and validation module 172 were to establish that each computed metric value satisfies threshold requirements, FI computing system 130 may deem the gradient-boosted, decision-tree process adaptively trained, and ready for deployment and real-time application to the elements of customer profile, account, transaction, insolvency, or credit-bureau data described herein. In some instances, executed adaptive training and validation module 172 may generate model data 180 that includes the model parameters of the adaptively trained, gradient-boosted, decision-tree process, such as, but not limited to, each of the candidate model parameters specified within candidate model data 174. Further, executed adaptive training and validation module 172 may also generate input data 182, which characterizes a composition of an input dataset for the adaptively trained, gradient-boosted, decision-tree process and identifies each of the discrete data elements within the input data set, along with a sequence or position of these elements within the input data set (e.g., as specified within candidate input data 176). As illustrated in FIG. 1B, executed adaptive training and validation module 172 may perform operations that store model data 180 and input data 182 within the one or more tangible, non-transitory memories of FI computing system 130, such as consolidated data store 144.

### B. Exemplary Processes for Predicting Future Occurrences of Insolvency Events using Adaptively Trained, Machine-Learning or Artificial-Intelligence Processes

In some examples, one or more computing systems associated with or operated by a financial institution, such as one or more of the distributed components of FI computing system 130, may perform operations that adaptively train a machine learning or artificial intelligence process to predict, during a current temporal interval, a likelihood of an occurrence of an insolvency event involving a customer during a future temporal interval using training data associated with a first prior temporal interval, and using validation data associated with a second, and distinct, prior temporal interval. As described herein, the machine-learning or artificial-intelligence process may include an ensemble or decision-tree process, such as a gradient-boosted, decision-tree process, and the training and validation data may include, but are not limited to, elements of the profile, account, transaction, and reporting data characterizing corresponding ones of the customers of the financial institution, along with elements of insolvency data identifying and characterizing prior occurrences of insolvency events associated with, or involving, the corresponding customers.

In some instances, FI computing system 130 may perform any of the exemplary processes described herein to generate input datasets associated with all, or a selected subset, of the customers of the financial institution, and to apply the adaptively trained machine-learning or artificial-intelligence process, such as the adaptively trained, gradient-boosted, decision-tree process described herein, to each of the input datasets. Based on the application of the adaptively trained machine-learning or artificial-intelligence process to each of the input datasets, FI computing system 130 may perform any of the exemplary processes described herein to generate corresponding elements of output data, each of which may indicate of a predicted likelihood of occurrence of an insolvency event involving a corresponding customer during a future temporal interval, such as, but not limited to, twelve-month interval between three and fifteen months from a corresponding prediction date.

By way of example, the selected subset may include one or more customers of the financial institution that hold an unsecured credit product issued by the financial institution, such as, but not limited to, a credit-card account, a personal loan, or another unsecured line-of-credit. As described herein, each of the unsecured credit products may be subject to one or more terms and conditions on a subsequent usage of the unsecured credit products and on a subsequent repayment of all, or a portion, of funds associated with the unsecured credit products, and the one or more terms and conditions of each of the unsecured credit products may be established by the financial institution initially upon issuance, and further, may be modified subsequent to issuance in accordance with the customers' use, or misuse, of these unsecured credit products. In some instances, FI computing system 130 may, in conjunction with other computing systems associated with the financial institution, perform any of the exemplary processes described herein to generate input datasets associated with the selected subset of the customers of the financial institution, and to apply the adaptively trained machine-learning or artificial-intelligence process to each of the input datasets in accordance with a predetermined temporal schedule (e.g., on a monthly basis), or in response to a detection of a triggering event.

As described herein, each of the generated elements of output data may include numerical score (e.g., ranging from zero to unity) indicative of a predicted likelihood that a corresponding one of the customers will be involved in an insolvency event during the future temporal interval (e.g., with zero being indicative of a minimal predicted likelihood, and unity being indicative of a maximum predicted likelihood). In some instances, and based on these numerical scores, FI computing system 130 may generate ranking data that orders each of the selected subset of the customers and their corresponding numerical scores in accordance with the predicted likelihood that each of the selected subset of the customers will be involved in an insolvency event during the future temporal interval, and may perform operations, in conjunction with one or more additional computing systems of the financial institution, that modify one or more of the terms and conditions of unsecured credit product for held by one or more of the selected subset of the customers (e.g., the portion of the selected subset of the customers associated with numerical scores exceeding a predetermined threshold, the portion of the selected subset of the customers associated with numerical scores that fall within 5% of a maximum numerical score for the customers, etc.).

Further, in some examples, a customer of the financial institution may request an unsecured credit product available for issuance by the financial institution, such as, but not limited to, an unsecured personal loan subject to certain terms and conditions on a subsequent usage of the unsecured personal loan and on a subsequent repayment of all, or a portion, of the unsecured loan. For example, a device operable by, or associated with, the customer may execute one or more application programs (e.g., a web browser or mobile application associated with the financial institution), and the executed application program may generate elements of data that identify and characterize the customer and the requested unsecured personal loan, and may perform operations that cause the device to transmit the generated elements of data across a communications network, such as network 120, to one or more additional computing systems of the financial institution, such as an issuer system associated with the unsecured credit product.

In some instances, and prior to issuing the requested credit product to the customers, the issuer system may provision data identifying the customer to FI computing system 130 (e.g., by transmission across network 120), which may perform any of the exemplary processes described herein to generate an input dataset associated with the customer, to apply the adaptively machine-learning or artificial-intelligence process to the generated input dataset, and based on the application of the machine-learning or artificial-intelligence process to the input dataset, generate an element of output data (e.g., the numerical score described herein) that indicates a predicted likelihood of an occurrence of an insolvency event involving the requested customer during the future temporal interval. FI computing system 130 may, in some examples, provision the generated element of output data to the issuer system, which may perform operations that generate initial terms and conditions for the requested credit product that are consistent with, and appropriate to, the predicted likelihood of the future occurrence of the insolvency vent involving the customer.

Through the implementation of the exemplary processes described herein, which adaptively train and validate a machine-learning or artificial-intelligence process (such as the gradient-boosted, decision-tree process described herein) using customer-specific training and validation datasets associated with respective training and validation intervals, and which apply the trained and validated machine-learning or artificial-intelligence process to additional customer-specific input datasets, FI computing system 130 may predict, in real-time, a likelihood of an occurrence of an insolvency even involving one or more customers of the financial institution during a predetermined, future temporal interval (e.g., via the implementation of the parallelized, fault-tolerant distributed computing and analytical protocols described herein across clusters of GPUs and/or TPUs). These exemplary processes may, for example, provide, to the financial institution, a real-time indication of the likelihood of a future insolvency event involving one or more customers, which may inform a determination of not only an initial set of terms and conditions associated with a newly issued credit product, but also a subsequent modification of an existing set of terms and conditions associated with a previously issued credit product.

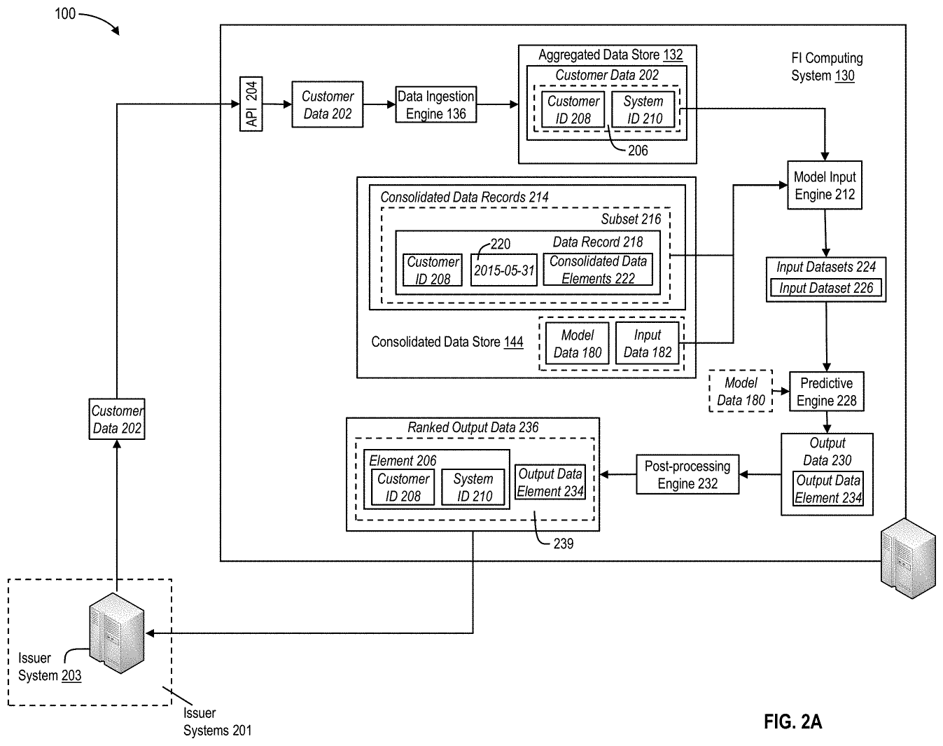

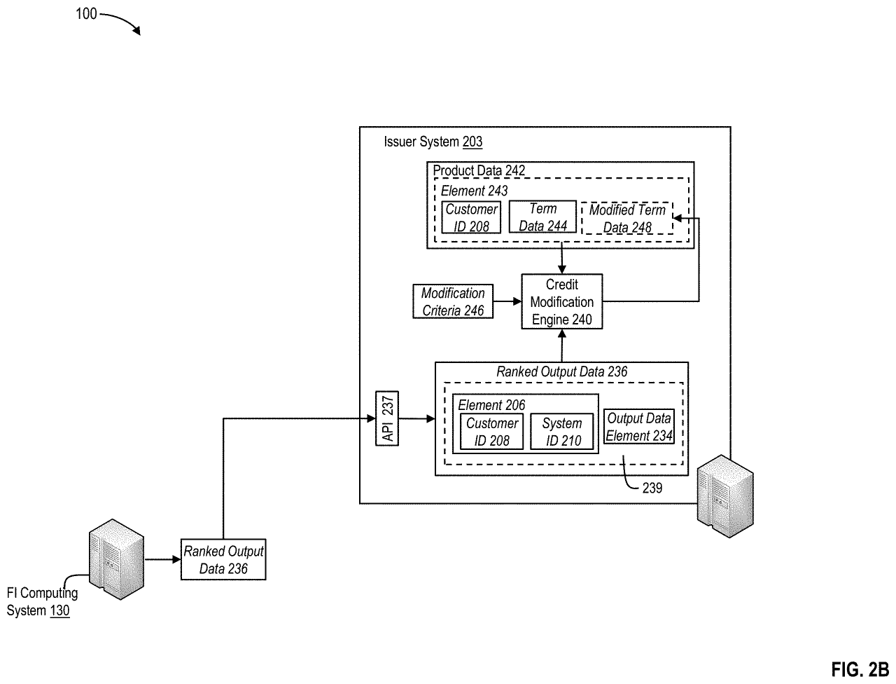

Referring to FIG. 2A, aggregated data store 132 of FI computing system 130 may maintain one or more elements of customer data 202. In some instances, each of the one or more elements of customer data 202 may be associated with a customer of the financial institution that holds one, or more issued financial products, such as an unsecured credit product. As described herein, examples of these unsecured credit products may include, but are not limited to, a credit-card account, an unsecured personal loan, or an unsecured line-of-credit, and each of the unsecured credit products may be associated with corresponding terms and conditions, which characterize a subsequent usage of the unsecured credit products and on a subsequent repayment of all, or a portion, of funds associated with the unsecured credit products. Further, as described herein, the financial institution may establish the terms and conditions for each of these unsecured credit products upon issuance to corresponding ones of the customers, and may selecting modify certain of the terms and conditions in response to the customers' use, or misuse, of the issued credit products.

FI computing system 130 may, for example, receive all, or a selected portion, of customer data elements 202 from one or more issuer systems 201 associated with the unsecured credit products, such as, but not limited to, issuer system 203 of FIG. 2A. In some instances, each of issuer systems 201, including issuer system 203, may represent a computing system that includes one or more servers and tangible, non-transitory memories storing executable code and application modules. Further, the one or more servers may each include one or more processors (such as a central processing unit (CPU)), which may be configured to execute portions of the stored code or application modules to perform operations consistent with the disclosed embodiments. Each of issuer systems 201, including issuer system 203, may also include a communications interface, such as one or more wireless transceivers, coupled to the one or more processors for accommodating wired or wireless internet communication with other computing systems and devices operating within environment 100. In some instances, each of issuer systems 201 (including issuer system 203) may be incorporated into a respective, discrete computing system, although in other instances, one or more of issuer systems 201 (such as issuer system 203) may correspond to a distributed computing system having a plurality of interconnected, computing components distributed across an appropriate computing network, such as communications network 120 of FIG. 1A, or to a publicly accessible, distributed or cloud-based computing cluster, such as a computing cluster maintained by Microsoft Azure™, Amazon Web Services™, Google Cloud™, or another third-party provider.

Referring back to FIG. 2A, an application program executed by the one or more processors of issuer system 203, and of additional, or alternate, ones of issuer systems 201, may transmit portions of customer data elements 202 across network 120 to FI computing system 130. The transmitted portions may be encrypted using a corresponding encryption key, such as a public cryptographic key associated with FI computing system 130, and a programmatic interface established and maintained by FI computing system 130, such as application programming interface (API) 204, may receive the portions of customer data 202 from issuer system 203, or from additional, or alternate, ones of issuer systems 201.

API 204 may, for example, route each of the elements of customer data 202 to executed data ingestion engine 136, which may perform operations that store the elements of customer data 202 within one or more tangible, non-transitory memories of FI computing system 130, such as within aggregated data store 132. In some instances, and as described herein, the received elements of customer data 202 may be encrypted, and executed data ingestion engine 136 may perform operations that decrypt each of the encrypted elements of customer data 202 using a corresponding decryption key (e.g., a private cryptographic key associated with FI computing system 130) prior to storage within aggregated data store 132. Further, although not illustrated in FIG. 2A, aggregated data store 132 may also store one or more additional elements of customer data identifying customers of the financial institution that hold corresponding ones of the unsecured credit products, and executed data ingestion engine 136 may perform one or more synchronization operation that merge the received elements of customer data 202 with the previously stored elements of customer data, and that eliminate any duplicate elements existing among the received elements of customer data 202 with the previously stored elements of customer data (e.g., through an invocation of an appropriate Java-based SQL “merge” command).

As described herein, each of the elements of customer data 202 may be associated with, and include a unique identifier of, a customer of the financial institution that holds one or more of unsecured credit products (e.g., the credit-card accounts, the unsecured personal loans, or the unsecured lines-of-credit), and FI computing system 130 may receive each of the elements of customer data 202 from a corresponding one of issuer systems 201, such as issuer system 203. For example, as illustrated in FIG. 2A, element 206 of customer data 202, which may be associated with a particular one of the customers and received from issuer system 203, may include a customer identifier 208 assigned to the particular customer by FI computing system 130 (e.g., an alphanumeric character string, etc.), and a system identifier 210 associated with issuer system 203 (e.g., an Internet Protocol (IP) address, a media access control (MAC) address, etc.). Further, although not illustrated in FIG. 2A, each additional, or alternate, element of customer data 202 may be associated with an additional customer of the financial institution that holds an unsecured credit product and received from a corresponding one of issuer systems 201, and may include a customer identifier associated with that additional customer and a system identifier associated with the corresponding one of issuer systems 201.

As described herein, FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a monthly basis), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from one or more of issuer systems 201.

In some instances, and in accordance with the predetermined temporal schedule, or upon detection of the triggering event, a model input engine 212 executed by FI computing system 130 may perform operations that access the elements of customer data 202 maintained within aggregated data store 132, and that obtain the customer identifier maintained within a corresponding one of the accessed elements of customer data 202. For example, as illustrated in FIG. 2A, executed model input engine 212 may access element 206 of customer data 202 (e.g., as maintained within aggregated data store 132) and obtain customer identifier 208, which includes, but is not limited to, the alphanumeric character string assigned to the particular customer of the financial institution.

Executed model input engine 212 may also access consolidated data store 144, and perform operations that identify, within consolidated data records 214, a subset 216 of consolidated data records that include customer identifier 208 and as such, are associated with the particular customer of the financial institution identified by element 206 of customer data 202. As described herein, each of consolidated data records 214 may be associated with a customer of the financial institution, and may characterize that customer, the interaction of that customer with the financial institution and with other financial institutions, and any associated insolvency events involving that customer during a corresponding temporal interval. For example, and as described herein, each of consolidated data records 214 may include a corresponding customer identifier (e.g., an alphanumeric character string assigned to a corresponding customer), a corresponding temporal identifier (e.g., that identifies the corresponding temporal interval), and one or more consolidated data elements associated with the corresponding customer. Examples of these consolidated data elements may include, but are not limited to, elements customer profile data, account data, transaction data. insolvency data, or credit-bureau data, which may be ingested, processed, aggregated, or filtered by FI computing system 130 using any of the exemplary processes described herein.

In some instances, and as illustrated in FIG. 2A, each of subset 216 may include customer identifier 208 and as such, may be associated with the particular customer identified by element 206 of customer data 202. Each of subset 216 of consolidated data records 214 may also include a temporal identifier of a corresponding temporal interval, and one or more consolidated elements associated with the particular customer, the interaction of particular customer with the financial institution and with other financial institutions, and any associated insolvency events involving the particular customer during corresponding ones of the temporal intervals. By way of example, data record 218 of subset 216 may include customer identifier 208, a corresponding temporal identifier 220 (e.g., “2021-05-31,” indicating a temporal interval spanning May 1, 2021, through May 31, 2021), and consolidated data elements 222, which identify and characterize the particular customer during the temporal interval spanning May 1, 2021, through May 31, 2021. Further, although not illustrated in FIG. 2A, each additional, or alternate, data records within subset 216 may include customer identifier 208, a temporal identifier of a corresponding temporal interval, and corresponding elements of consolidated data that identify and characterize the particular customer during the corresponding temporal interval.

Executed model input engine 212 may also perform operations that obtain, from consolidated data store 144, elements of input data 182 characterize a composition of an input dataset for the adaptively trained, gradient-boosted, decision-tree process. In some instances, executed model input engine 212 may parse input data 182 to obtain the composition of the input dataset, which not only identifies the elements of customer-specific data included within each input data set dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 166 and packaged into corresponding potions of training datasets 170, as described herein.

In some instances, and based on the parsed portions of input data 182, executed model input engine 212 may that identify, and obtain or extract, one or more of the input feature values from one or more of data records maintained within subset 216 of consolidated data records 214 and associated with temporal intervals disposed within the extraction interval Δt_{extract}, as described herein. Executed model input engine 212 may perform operations that package the obtained, or extracted, input feature values within a corresponding one of input datasets 224, such as input dataset 226 associated with the particular customer identified by element 206 of customer data 202, in accordance with their respective, specified sequences or positions. Further, in some examples, and based on the parsed portions of input data 182, executed model input engine 212 may perform operations that compute, determine, or derive one or more of the input features values based on elements of data extracted or obtained from the additional ones of the consolidated data records, as described herein. Executed model input engine 212 may perform operations that package each of the computed, determined, or derived input feature values into portions of input datasets 226 in accordance with their respective, specified sequences or positions.

Through an implementation of these exemplary processes, executed model input engine 212 may populate an input dataset associated with the particular customer identified by element 206 of customer data 202, such as input dataset 226 of input datasets 224, with input feature values obtained or extracted from, or computed, determined or derived from element of data within, the data records of subset 216. Further, in some instances, executed model input engine 212 may also perform any of the exemplary processes described herein to generate, and populate with input feature values, an additional one of input datasets 224 for each of the additional, or alternate, customers of the financial institution associated with additional, or alternate, elements of customer data 202. Executed model input engine 212 may package each of the discrete, customer-specific input datasets within input datasets 224, and executed model input engine 212 may provide input datasets 224 as an input to a predictive engine 228 executed by the one or more processors of FI computing system 130.

As illustrated in FIG. 2A, executed predictive engine 228 may perform operations that obtain, from consolidated data store 144, model data 180 that includes one or more model parameters of the adaptively trained, gradient-boosted, decision-tree process. For example, and as described herein, the model parameters included within model data 180 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some examples, and based on portions of model data 180, executed predictive engine 228 may perform operations that establish a plurality of nodes and a plurality of decision trees for the adaptively trained, gradient-boosted, decision-tree process, each of which receive, as inputs (e.g., “ingest”), corresponding elements of input datasets 224. Further, and based on the execution of predictive engine 228, and on the ingestion of input datasets 224 by the established nodes and decision trees of the adaptively trained, gradient-boosted, decision-tree process, FI computing system 130 may perform operations that apply the adaptively trained, gradient-boosted, decision-tree process to each of the input datasets of input datasets 224, including input dataset 226, and that generate an element of output data 230 associated with a corresponding one of input datasets 224, and as such, a corresponding one of the customers identified by the elements of customer data 202. As described herein, each of the generated elements of output data 230 may include a numerical score indicative of a predicted likelihood that the corresponding one of the customers will be involved in an insolvency event during the future temporal interval (e.g., the target interval Δt_{target}, described herein). In some examples, the numerical score within each of the elements of output data 230 may range from zero to unity, with zero being indicative of a minimal predicted likelihood, and unity being indicative of a maximum predicted likelihood.

As illustrated in FIG. 2A, executed predictive engine 228 may provide the generated elements of output data 230 (e.g., either alone, or in conjunction with corresponding ones of input datasets 224) as an input to a post-processing engine 232 executed by the one or more processors of FI computing system 130. In some instances, and upon receipt of the generated elements of output data 230 (e.g., and additionally, or alternatively, the corresponding ones of input datasets 224), executed post-processing engine 232 may perform operations that access the elements of customer data 202 maintained within consolidated data store 144, and associate each of the elements of customer data 202 (e.g., that identify a corresponding one of the customers of the financial institution that hold an unsecured credit product) with a corresponding one of the elements of output data 230 (e.g., that include numerical scores indicative of the predicted likelihood that corresponding ones of the customers will be involved in an insolvency event during the future temporal interval).

By way of example, element 234 of output data 230 may be associated with the particular customer identified by element 206 of customer data 202, and may include a numerical score (e.g., 0.77) indicative of the predicted likelihood that the particular customer will be involved in an insolvency event during the future temporal interval. Executed post-processing engine 232 may, in some instances, associate element 206 of customer data 202 with element 234 of output data, and may perform any of these exemplary processes to associate each additional, or alternate, one of the elements of output data 230 with a corresponding one of the elements of customer data 202. Further, and in some instances, executed post-processing engine 232 may perform operations that rank the associated elements of customer data 202 and output data 230 based on magnitudes of the corresponding numerical scores (e.g., which indicate the predicted likelihood that corresponding ones of the customer will be involved in an insolvency event during the future temporal interval), and output elements of ranked output data 236 that include the associated, and now ranked, elements of customer data 202 and output data 230. For example, and for a particular customer of the financial institution, ranked output data 236 may include a corresponding ranked element 239 that associates together element 206 of customer data 202 (which includes customer identifier 208 of the particular customer) and element 234 of output data 230 (which specifies a numerical score of 0.77 for the particular customer).

In some instances, by ranking the associated elements of elements of customer data 202 and output data 230 in accordance with the respective numerical scores, FI computing system 130 may identify those customers of the financial institution that represent the greatest insolvency risk to the financial institution during the future temporal interval. As illustrated in FIG. 2A, FI computing system 130 may perform operations that transmit all, or a selected portion of, ranked output data 236 to issuer system 203 and additionally, or alternatively, to other ones of issuer systems 201. By way of example, FI computing system 130 may obtain system identifier included within each of the associated elements of customer data 202 and output data 230 within ranked output data 236 (e.g., system identifier 210 maintained within element 239 of ranked output data 236), and perform operations that transmit each of the pairs of ranked and associated elements of customer data 202 and output data 230 to a corresponding one of issuer system 201, including issuer system 203, associated with the obtained system identifier. Further, although not illustrated in FIG. 2A, FI computing system 130 may also encrypt all, or a selected portion of, ranked output data 236 prior to transmission across network 120 using a corresponding encryption key, such as, but not limited to, a corresponding public cryptographic key associated with a corresponding one of issuer systems 201, such as issuer system 203.

Referring to FIG. 2B, one or more of issuer systems 201, such as issuer system 203, may receive, all, or a selected portion, of ranked output data 236 from FI computing system 130. For example, a programmatic interface associated with and maintained by issuer system 203, such as application programming interface (API) 237, may receive and route ranked output data 236 to a credit modification engine 240 executed by the one or more processors of issuer system 203. As described herein, ranked output data 236 may rank, and associated together, elements of customer data 202 (e.g., that identifying and characterize corresponding customer of the financial institution) and output data 230 (which include numerical scores indicative of a predicted likelihood that the corresponding ones of the customers will be involved in an insolvency event during the future temporal interval). For example, and for a particular customer of the financial institution, ranked output data 236 may include a corresponding ranked element 239 that associates together element 206 of customer data 202 (which includes customer identifier 208 of the particular customer) and element 234 of output data 230 (which specifies a numerical score of 0.77 for the particular customer).

In some instances, executed credit modification engine 240 may perform operations that parse each the elements of ranked output data 236 (including element 239) to determine, for a corresponding one of the customers of the financial institution, whether to modify one or more terms or conditions of an issued, unsecured credit product based on the corresponding numerical score and as such, in accordance with the predicted likelihood that the corresponding customer will be involved in an insolvency event during the future temporal interval (e.g., the target temporal interval Δt_{target} described herein). For example, executed credit modification engine 240 may access element 239 of ranked output data 236, and obtain customer identifier 208 of the particular customer of the financial institution (e.g., from element 206) and the predicted numerical score associated with that particular customer (e.g., from output data element 234). Further, executed credit modification engine 240 may access product data 242 (e.g., as maintained within one or more tangible, non-transitory memories of issuer system 203), which characterizes terms and conditions of unsecured credit products issued to customers of the financial institution, and obtain element 243 that includes customer identifier 208 and term data 244, which identifies one or more terms and conditions of an unsecured credit product issued to the particular customer by the financial institution. For example, the unsecured credit product may include a credit-card account, and term data 244 may include, among other things, an identifier of an unsecured credit instrument issued to the particular customer (e.g., a credit-card account), an amount of credit extended to the particular customer, a repayment schedule, an interest rate, or a penalty imposed upon the particular customer by the financial institution in response to a determined violation of the terms or conditions.

Further, as illustrated in FIG. 2B, executed credit modification engine 240 may also access modification criteria 246 associated with the terms and conditions of the issued, unsecured credit products. In some instances, modification criteria 246 may include, for a particular ones of the unsecured credit products, one or more threshold criteria that, if satisfied by the elements of ranked output data 236, would trigger a modification of the terms and conditions of the particular ones of the unsecured credit products. Further, modification criteria 246 may also specify one or more modifications to the terms and conditions that would be appropriate to the threshold criteria. By way of example, and for an issued credit-card account, modification criteria 246 may specify one or more threshold values for the predicted numerical scores within the elements of ranked output data 236 (e.g., respective threshold values of 0.25, 0.5, and 0.75) and appropriate modifications to the terms and conditions for each of the threshold values (e.g., respective modifications that an increase the annual percentage rate (APR) for balances associated with the credit card account, that further increase in the APR and reduce the amount of extended credit associated with the credit-card account, and that further increase the APR, further reduce the amount of extended credit, and increase the minimum payment associated with the credit-card account). The disclosed embodiments are, however, not limited to these exemplary threshold criteria or appropriate modifications, and in other instances, modification criteria 246 may include other threshold criteria, and other modifications, that would be appropriate to the each of the unsecured credit instruments issued to customers by the financial institution and a level of insolvency risk associated with these customers, such as, but not limited to, a threshold criteria applicable to a threshold percentages of customers associated with the largest insolvency risk (e.g., those customers having numerical scores within 5% of a maximum score).

For example, executed credit modification engine 240 may parse element 239 of ranked output data 236, and determine that output data element 234 specifies a numerical score for the particular customer, e.g., 0.77. Based on portions of term data 244, executed credit modification engine 240 may determine that the financial institution issued the credit-card account to the particular customer, and may determine that the numerical score of 0.77 associated with the particular customer exceeds the threshold value of 0.75, as specified within modification criteria 246. Further, and based on the determined violation of the threshold criterion, executed credit modification engine 240 may impose, among other things, an increase the APR associated with the credit-card account issued to the particular customer, a reduction the amount of extended credit associated with the credit-card account, and an increase the minimum payment associated with the credit-card account. Executed credit modification engine 240 may perform operations that generate one or more elements of modified term data 248, which identify and characterize the modifications to the terms and conditions imposed on the credit-card account issued to the particular customer, and store the modified term data 248 within a portion of product data 242 associated with customer identifier 208.

Executed credit modification engine 240 may also perform any of the exemplary processes described herein to determine, for a customer of the financial institution associated with each additional, or alternate, element of ranked output data 236, whether to modify one or more terms or conditions of an issued, unsecured credit product, in accordance with the predicted likelihood that the corresponding customer will be involved in an insolvency event during a future temporal interval. Further, although not illustrated in FIG. 2B, issuer system 203 may perform operations that generate, and transmit across network 120, a notification characterizing each of the modified terms and conditions to a device associated with, or operated by, corresponding ones of the customers of the financial institution.

As described herein, FI computing system 130 may perform operations that, in conjunction with one or more of issuer systems 201, apply an adaptively trained, gradient-boosted, decision-tree process to customer-specific input datasets characterizing all, or a selected subset, of the customers of the financial institution during a prior temporal interval (e.g., the extraction interval Δt_{extract}, described herein), and based on the application of that apply an adaptively trained, gradient-boosted, decision-tree process to the customer-specific input datasets, generate elements of output data indicative of a predicted likelihood of occurrences of insolvency events involving all, or the subset of, the customers during a future temporal interval (e.g., the target interval Δt_{target}, described herein). In some instances, also described herein the extraction interval Δt_{extract} may be separated temporally from the target interval Δt_{target} by a corresponding buffer interval (e.g., the buffer interval Δt_{buffer}, described herein). Further, examples of the extraction, buffer, and target intervals may include, but are not limited to, respective ones of a one-month interval, a three-month interval, and a twelve-month interval, and in some instances, each of the generated elements of output data may include a numerical score indicative of the predicted likelihood that a corresponding customer of the financial institution may be involved in, or experience, an insolvency event within three to fifteen months of a corresponding prediction data (e.g., the prediction date t_{pred}, described herein).

FI computing system 130 may also perform any of the exemplary processes described herein to generate the input datasets that characterize all, or the selected subset of, the customers during the prior temporal interval (e.g., input datasets 224 of FIG. 2A), to apply the adaptively trained, gradient-boosted, decision-tree process to the customer-specific input datasets, and to generate the elements of output data (e.g., output data 230 of FIG. 2A), and further, to rank the elements of output data 230 and provision ranked elements of output data (e.g., ranked output data 236 of FIG. 2B) to one or more of issuer systems 201 in accordance with a predetermined schedule (e.g., on a monthly basis, etc.). As described herein, to generate of the customer-specific input datasets for each customer of the financial institution, or even the selected subset of these customers (e.g., those customers that hold unsecured credit products), FI computing system 130 may ingest, preprocess, and maintain elements of customer profile, account, transaction, insolvency, or credit-bureau data identifying and characterizing potentially millions of customers of the financial institution over various temporal intervals.

In some instances, FI computing system 130 may maintain the data within aggregated data store 132, such as but not limited to, the elements of ingested customer data 138, and the preprocessed data within consolidated data store 144, such as consolidated data records 142, 152, and/or 214, in sparse-vector format to utilize efficiently memory within the distributed file system. Further, the distributed components of FI computing system 130 may perform any of the exemplary processes described herein in parallel to generate the customer-specific input datasets for the potentially millions of customers, and to apply the adaptively trained, gradient-boosted, decision-tree model to the customer-specific input datasets, and to generate the customer-specific elements of output data indicative of the predicted likelihood of the future insolvency events (e.g., via the implementation of the parallelized, fault-tolerant distributed computing and analytical protocols described herein across clusters of GPUs and/or TPUs, as described herein).

These exemplary processes may provide, to the financial institution, a real-time indication of the likelihood of a future insolvency event involving one or more customers, which may inform a determination of not only an initial set of terms and conditions associated with a newly issued credit product, but also a subsequent modification of an existing set of terms and conditions associated with a previously issued credit product. For example, as described herein, one or more of issuer systems 201, including issuer system 203, may receive ranked elements of predictive output data (e.g., elements of ranked output data 236 of FIGS. 2A and 2B), which predict a likelihood that the one or more customers will be involved in, or experience, an insolvency event during a future temporal interval (e.g., the target interval Δt_{target} described herein) in accordance with a predetermined schedule, such as, but not limited to, on a monthly basis. Based on the ranked elements of the predictive output data, one or more of issuer systems 201, such as issuer system 203, may perform operations that the modify a term or condition associated with an unsecured credit product held by at least one of these customers to reflect a risk that the at least one of the customers will experience, or be involved in, an insolvency event during the future temporal interval.

By way of example, issuer system 203 may perform operations that issue one or more credit products to customers of the financial institution (e.g., the one or more of the credit-card accounts, the unsecured personal loans, or the unsecured lines-of-credit described herein), and each of the issued unsecured credit products may be associated with a corresponding set of initial conditions. In some instances, the ranked elements of predictive output data (e.g., elements of ranked output data 236 described herein) may each be associated with a corresponding one of the customers of the financial institution that hold the unsecured credit product issued by issuer system 203, and issuer system 203 may perform any of the exemplary processes described herein (e.g., via the operations performed by executed credit modification engine 240, as described herein) to modify the terms and conditions associated with the unsecured credit instruments held by at least one of the customers based on corresponding ones of the ranked elements of predictive output data.

For instance, executed credit modification engine 240 of issuer system 203 may perform any of the exemplary processes described herein to modify the terms and conditions associated with the unsecured credit instruments held by those customers associated with a ranked element of predictive output data having a numerical score that exceeds a predetermined threshold value (e.g., a predetermined threshold value of 0.5, which indicates a predicted 50% likelihood that those customers experience, or be involved in, the insolvency event during the future temporal interval). Additionally, or alternatively, executed credit modification engine 240 may perform operations that, based on the elements of predictive output data (e.g., the elements of ranked output data 236), establish that a subset of the customers that hold the unsecured credit products are at an elevated risk of default during the future temporal interval, and may perform any of the exemplary processes described herein to modify the terms and conditions associated with the unsecured credit instruments held by those customers characterized by the elevated risk of insolvency. For example, executed credit modification engine 240 may perform operations that parse the ranked elements of output data (each of which include a corresponding numerical score) to identify a maximum of the numerical scores, and that characterize those customers associated with a corresponding one of the numerical scores disposed within a predetermined range of that maximum score (e.g., within 5% of the maximum score, etc.).

In other examples, and in addition to characterizing those customers of the financial institution that hold the unsecured credit products issued by issuer system 203, the ranked elements of predictive output data received by issuer system 203 may also characterize customers that hold other unsecured credit instruments or other financial products issued by the financial institution (e.g., unsecured credit products or financial products and associated with additional, or alternate, ones of issuer systems 201). The broader composition of the ranked elements of predictive output data may, for instance, enable issuer system 203 to perform operations that establish a set of initial terms and conditions for an unsecured credit product requested by a corresponding customer of the financial institution, e.g., based on a determined risk that the corresponding customer will be experience, or be involved in, an insolvency event during the future temporal interval. For example, issuer system 203 (or an additional, or alternate, one of issuer systems 201) may receive a request to obtain an unsecured credit product, such as an unsecured line-of-credit, from a device operated by a requesting customer (e.g., via a mobile banking application executed by that device and associated with the financial institution).

Issuer system 203 may, for example, parse the received request and obtain a customer identifier associated with the requesting customer, and based on the obtained identifier, issuer system 203 may access a corresponding one of the ranked elements of output data that includes, or is associated with, the customer identifier (e.g., one of the elements of ranked output data 236). The corresponding one of the ranked elements may include a numerical score indicative of a predicted likelihood that the requesting customer will experience, or will be involved in, and insolvency event during the future temporal interval, e.g., as generated by FI computing system based on the application of the adaptively trained, gradient-boosted, decision-tree process to a corresponding input data set. Based on the numerical score, and the predicted likelihood of the occurrence of the insolvency event during the future temporal interval, issuer system 203 may perform any of the exemplary processes described herein to determine one or more initial terms and conditions for the requested unsecured personal loan, and transmit data identifying the initial terms and conditions for the requested unsecured personal loan to the device, e.g., for presentation to the requesting customer within a corresponding digital interface.

Further, in some instances, issuer system 203 may, upon receipt of the request from the device operable by the customer, perform additional operations that package all or a portion of the received request, including the customer identifier, into a portion of an additional request that, when transmitted to FI computing system 130 across network 120, causes FI computing system 130 to perform any of the exemplary processes described herein to generate a customer-specific dataset based on the customer identifier, to apply the adaptively trained, gradient-boosted, decision-tree process to the customer-specific dataset, and based on the application of the adaptively trained, gradient-boosted, decision-tree process to the customer-specific dataset, generate an element of output data indicative of a predictive likelihood that the requested customer will experience, or be involved in, and insolvency event during the future temporal interval. For example, a programmatic interface established and maintained by FI computing system 130, such as API 204, may receive and route the received customer request, which includes the customer identifier, to executed model input engine 212.

Executed model input engine 212 may obtain the customer identifier from the customer request, and may access one or more consolidated data records maintained within consolidated data store 144 (e.g., consolidated data records 214 of FIG. 2A) that include or reference the customer identifier and as such, as associated with the requesting customer. Based on the one or more accessed consolidated data records, executed model input engine 212 may perform any of the exemplary processes described herein to generate a customer-specific input dataset consistent with the composition and sequence specified by input data 182. Executed model input engine 212 may provision the customer-specific input dataset to executed predictive engine 228, which may perform any of the exemplary processes described herein to apply the adaptively trained, gradient-boosted, decision-tree process to the customer-specific input dataset, and to generate the element of output data indicative of the predictive likelihood that the requested customer will experience, or be involved in, and insolvency event during the future temporal interval.

Responsive to the generation of the element of output data, FI computing system 130 may perform operations that transmit the generated element of output data, which includes the corresponding numerical score indicative of the predicted likelihood of the future occurrence of the insolvency event, across network 120 to issuer system 203. Issuer system 203 may, for example, perform any of the exemplary processes described herein to determine one or more initial terms and conditions for the requested unsecured personal loan based on the numerical score (and the predicted likelihood of the occurrence of the insolvency event during the future temporal interval) issuer system 203 may perform any of the exemplary processes described herein, and transmit data identifying the initial terms and conditions for the requested unsecured personal loan to the device, e.g., for presentation to the requesting customer within a corresponding digital interface.

In some example, and as described herein, the distributed components of FI computing system 130 may perform any of the exemplary processes described herein in parallel to generate the customer-specific input dataset, to apply the adaptively trained, gradient-boosted, decision-tree model to the customer-specific input dataset, and to generate the customer-specific element of output data indicative of the predicted likelihood of the future insolvency event (e.g., via the implementation of the parallelized, fault-tolerant distributed computing and analytical protocols described herein across clusters of GPUs and/or TPUs, as described herein). Through the parallel implementation of these processes, FI computing system 130 may generate and provision the customer-specific element of output data to issuer system 203 in real-time and contemporaneously with the receipt of the corresponding request for the unsecured credit product at issuer system 203 (e.g., the request for the unsecured personal loan generated by the device operable by the customer), and the receipt of the additional request for the output data from issuer system 203.

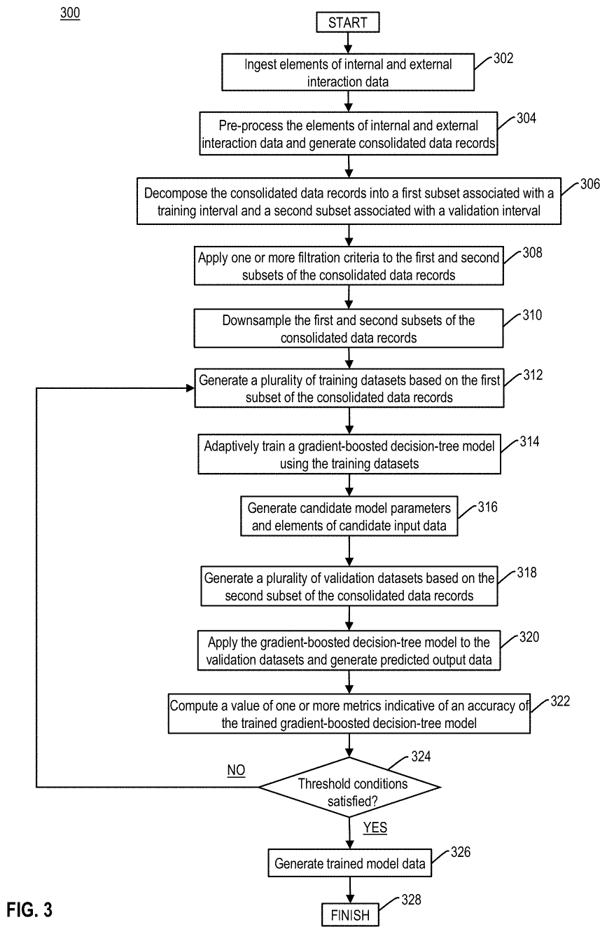

FIG. 3 is a flowchart of an exemplary process 300 for adaptively training a machine learning or artificial intelligence process to predict a likelihood of an occurrence of an event during a future temporal interval using training datasets associated with a first prior temporal interval, and using validation datasets associated with a second, and distinct, prior temporal interval. As described herein, the machine-learning or artificial-intelligence process may include an ensemble or decision-tree process, such as a gradient-boosted decision-tree process (e.g., the XGBoost model), and the event may include, but is not limited to, an insolvency event involving one or more customers of a financial institution. In some instances, one or more computing systems, such as, but not limited to, one or more of the distributed components of FI computing system 130, may perform one or of the steps of exemplary process 300, as described herein.

Referring to FIG. 3, FI computing system 130 may perform any of the exemplary processes described herein to establish a secure, programmatic channel of communication with one or more source computing systems, such as source systems 110 of FIG. 1A, and to obtain, from the source computing systems, elements of internal and external interaction data that identify and characterize one or more customers of the financial institution (e.g., in step 302 of FIG. 3). The elements of internal customer data may include, but are not limited to, one or more elements of customer profile, account, transaction, and/or insolvency data associated with corresponding ones of the customers, and the elements of external customer data may include, but are not limited to, elements of reporting or credit-bureau data associated with corresponding ones of the customers. FI computing system 130 may also perform operations that store (or ingest) the obtained elements of internal and external customer data within one or more accessible data repositories, such as aggregated data store 132 (e.g., also in step 302 of FIG. 3). In some instances, FI computing system 130 may perform the exemplary processes described herein to obtain and ingest the elements of elements of internal and external customer data in accordance with a predetermined temporal schedule (e.g., on a monthly basis), or a continuous streaming basis, across the secure, programmatic channel of communication.

Further, FI computing system 130 may access the ingested elements of internal and external interaction data, and may perform any of the exemplary processes described herein to pre-process the ingested elements of internal and external interaction data elements (e.g., the elements of customer profile, account, transaction, insolvency, and/or reporting or credit bureau data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with a particular one of the customers, and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of customer profile, account, transaction, insolvency, or credit-bureau data that characterize the particular customer during the corresponding temporal interval associated with the temporal identifier.

In some instances, FI computing system 130 may perform any of the exemplary processes described herein to decompose the consolidated data records into (i) a first subset of the consolidated data records having temporal identifiers associated with a first prior temporal interval (e.g., the training interval Δt_{training}, as described herein) and (ii) a second subset of the consolidated data records having temporal identifiers associated with a second prior temporal interval (e.g., the validation interval Δt_{validation}, as described herein), which may be separate, distinct, and disjoint from the first prior temporal interval (e.g., in step 306 of FIG. 3). By way of example, portions of the consolidated data records within the first subset may be appropriate to train adaptively the machine-leaning or artificial process (e.g., the gradient-boosted decision model described herein during the training interval Δt_{training}, and portions of the consolidated records within the second subset may be appropriate to validating the adaptively trained gradient-boosted decision model during the validation interval Δt_{validation}.

FI computing system 130 may also perform any of the exemplary processes described herein to filter the consolidated data records of the first and second subsets in accordance with one or more filtration criteria (e.g., in step 308 of FIG. 3). By way of example, and without limitation, the one or more filtration criteria may cause FI computing system 130 to exclude, from the first and second subsets of consolidated data records, a consolidated data record of any customer associated with an occurrence of an insolvency event during, or prior to, the temporal interval associated with the corresponding temporal identifier.

Further, and as described herein, the consolidated data records within first subset or within the second subset may represent an imbalanced data set in which the actual instances of insolvency within a future temporal interval associated with adaptively trained machine learning or artificial intelligence process (e.g., the target interval Δt_{target} associated with the adaptively trained, gradient-boosted, decision-tree process described herein) are outnumbered disproportionately by actual instances of solvency within the target prediction interval Δt_{target}. Given the imbalanced character of the first and second subsets, FI computing system 130 may also perform any of the exemplary processes described herein to downsample the consolidated data records within the first and second subsets that are associated with the actual instances of solvency (e.g., in step 310 of FIG. 3). In some instances, the downsampled data records maintained within each of the first and second subsets may represent, respectively, a balanced data set characterized by a more proportionate balance between the actual instances of solvency and insolvency.

In some instances, FI computing system 130 may perform any of the exemplary processes described herein to generate a plurality of training datasets based on elements of data obtained, extracted, or derived from all or a selected portion of the first subset of the consolidated data records (e.g., in step 312 of FIG. 3). By way of example, each of the plurality of training datasets may be associated with a corresponding one of the customers of the financial institution and a corresponding temporal interval, and may include, among other things a customer identifier associated with that corresponding customer and a temporal identifier representative of the corresponding temporal interval, as described herein. Further, and as described herein, each of the plurality of training datasets may also elements of data (e.g., feature values) that characterize the corresponding one of the customers, the corresponding customer's interaction with the financial institution or with other financial institution, and/or an occurrence (or lack thereof) of insolvency events involving the corresponding customer during a temporal interval disposed prior to the corresponding temporal interval, e.g., during the extraction interval Δt_{extract} described herein. Further, each of the plurality of training datasets may also include an element of ground-truth data indicative of the presence or absence of an actual insolvency event associated with a corresponding one of the customers within a corresponding target prediction interval Δt_{target}, such as, but not limited to, a twelve-month period disposed between three and fifteen months of the date specified by the temporal identifier).

Based on the plurality of training datasets, FI computing system 130 may also perform any of the exemplary processes described herein to train adaptively the machine-learning or artificial-intelligence process (e.g., the gradient-boosted decision-tree process described herein) to predict, during a current temporal interval, a likelihood of occurrences of insolvency events involving customers of the financial institution during a future temporal interval (e.g., in step 314 of FIG. 3). For example, and as described herein, FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate model parameters that characterize the adaptively trained machine-learning or artificial-intelligence process, such as, but not limited to, candidate model parameters for the adaptively trained, gradient-boosted, decision-tree process described herein (e.g., in step 316 of FIG. 3). In some instances, and for the adaptively trained, gradient-boosted, decision-tree process, the candidate model parameters included within candidate model data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, FI computing system 130 may perform any of the exemplary processes described herein to generate candidate input data, which specifies a candidate composition of an input dataset for the adaptively trained machine-learning or artificial intelligence process, such as the adaptively trained, gradient-boosted, decision-tree process (e.g., also in step 316 of FIG. 3).

Further, FI computing system 130 may perform any of the exemplary processes described herein to access the second subset of the consolidated data records, and to generate a plurality of validation subsets having compositions consistent with the candidate input data (e.g., in step 318 of FIG. 3). As described herein, each of the plurality of the validation datasets may be associated with a corresponding one of the customers of the financial institution, and with a corresponding temporal interval within the validation interval Δt_{validation}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the customers, and obtained, extracted, or derived from corresponding ones of the accessed second subset of the consolidated data records (e.g., during the corresponding extraction interval Δt_{extract}, as described herein).

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 320 of FIG. 3). As described herein, each of the generated elements of output data may be associated with a respective one of the validation datasets and as such, a corresponding one of the customers of the financial institution. Further, each of the generated elements of output data may also a numerical score (e.g., ranging from zero to unity) indicative of a predicted likelihood that the corresponding one of the customers will experience, or will be involved in, an insolvency event within a future temporal interval, such as, but not limited to, a twelve-month interval disposed between three and fifteen months from the date specified by the temporal identifier within the respective one of the validation datasets.

Further, and as described herein, the distributed components of FI computing system 130 may perform any of the exemplary processes described herein in parallel to validate the adaptively trained, gradient-boosted, decision-tree process described herein based on the application of the adaptively trained, gradient-boosted, decision-tree process (e.g., configured in accordance with the candidate model parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 322 of FIG. 3), and to determine whether all, or a selected portion of, the computed metric values satisfy one or more threshold conditions for a deployment of the adaptively trained machine-learning or artificial intelligence process (e.g., in step 324 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve or a computed value of an AUC for a receiver operating characteristic (ROC) curve associated with the adaptively trained, gradient-boosted, decision-tree process.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC values. In some examples, FI computing system 130 may perform any of the exemplary processes described herein to establish whether one, or more, of the computed recall-based values, the computed precision-based values, or the computed AUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 324; NO), FI computing system 130 may establish that the adaptively trained machine-learning or artificial-intelligence process (e.g., the adaptively trained, gradient-boosted, decision-tree process) is insufficiently accurate for deployment and a real-time application to the elements of customer profile, account, transaction, insolvency, or credit-bureau data described herein. Exemplary process 300 may, for example, pass back to step 312, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 324; YES), FI computing system 130 may deem the machine-learning or artificial intelligence process (e.g., the gradient-boosted, decision-tree process described herein) adaptively trained and ready for deployment and real-time application to the elements of customer profile, account, transaction, insolvency, or credit-bureau data described herein, and may perform any of the exemplary processes described herein to generate trained model data that includes the candidate model parameters and candidate input data associated with the of the adaptively trained machine-learning or artificial intelligence process (e.g., in step 326 of FIG. 3). Exemplary process 300 is then complete in step 328.

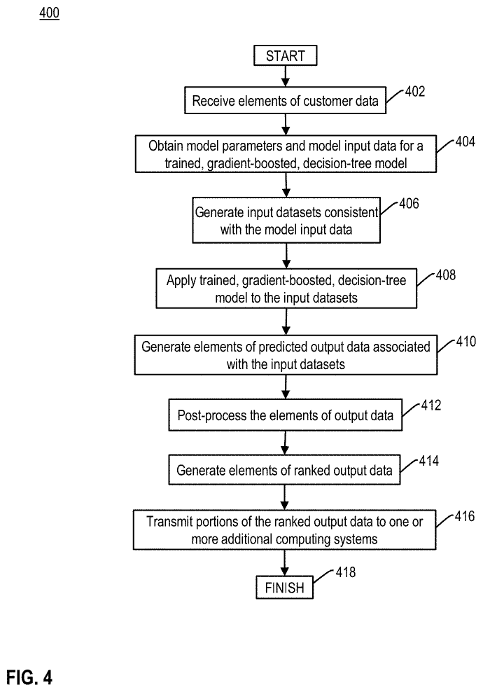

FIG. 4 is a flowchart of an exemplary process 400 for predicting a likelihood of future occurrences of events involving one or more customers of a financial institution based on an application of an adaptively trained machine-learning or artificial-intelligence process to customer-specific input datasets, in accordance with the disclosed exemplary embodiments. As described herein, the events may include one or more insolvency events involving corresponding ones of the customers, and the machine-learning or artificial-intelligence process may include an ensemble or decision-tree process, such as a gradient-boosted decision-tree process (e.g., the XGBoost model), which may be trained adaptively to predict a likelihood of an occurrence of an insolvency event during a future temporal interval using training datasets associated with a first prior temporal interval (e.g., the training interval Δt_{training}, as described herein), and using validation datasets associated with a second, and distinct, prior temporal interval (e.g., the validation interval Δt_{validation}, as described herein). In some instances, one or more computing systems, such as, but not limited to, one or more of the distributed components of FI computing system 130, may perform one or of the steps of exemplary process 300, as described herein.

Referring to FIG. 4, FI computing system 130 may perform any of the exemplary processes described herein to receive elements of customer data that identify one or more customers of the financial institution (e.g., in step 402 of FIG. 4). For example, FI computing system 130 may receive the elements of customer data from one or more additional computing systems associated with, or operated by, the financial institution (such as, but not limited to, one or more of issuer systems 201, including issuer system 203), and in some instances, FI computing system 130 may perform any of the exemplary processes described herein to store the obtained elements of customer data within a locally accessible data repository (e.g., within aggregated data store 132). Further, in some instances, FI computing system 130 may also perform any of the exemplary processes described herein to synchronize and merge the obtained elements of customer data with one or more previously ingested elements of customer data maintained within the locally accessible data repository. As described herein, each of the elements of customer data may be associated with a corresponding one of the customers, and may include a customer identifier associated with the corresponding one of the customers (e.g., the alphanumeric character string, etc.) and a system identifier associated with a corresponding one of the additional computing systems (e.g., an IP or MAC address of issuer system 203, etc.).

FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a monthly basis), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from one or more of issuer systems 201.

For example, FI computing system 130 may also perform any of the exemplary processes described herein to obtain one or more model parameters that characterize the adaptively trained machine-learning or artificial-intelligence process (e.g., the adaptively trained, gradient-boosted, decision-tree process described herein) and elements of model input data that specify a composition of an input dataset for the adaptively trained machine-learning or artificial-intelligence process (e.g., in step 404 of FIG. 4). In some instances, and for the adaptively trained, gradient-boosted, decision-tree process described herein, the one or more model parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, the elements of model input data may specify the composition of the input dataset for the adaptively trained, gradient-boosted, decision-tree process, which not only identifies the elements of customer-specific data included within each input data set dataset (e.g., input feature values, as described herein), but also a specified sequence or position of these input feature values within the input dataset.

In some instances, FI computing system 130 may access the elements of customer data associated with one or more customers of the financial institution, and may perform any of the exemplary processes described herein to generate, for the one or more customers, an input dataset having a composition consistent with the elements of model input data (e.g., in step 406 of FIG. 4). By way of example, and as described herein, the elements of customer data may include customer identifiers associated with each of the customers of the financial institution, or with a selected subset of these customers (e.g., those customers that hold an unsecured credit product issued by the financial institution), and FI computing system 130 may generate the input datasets for each of these customers in accordance with a predetermined schedule (e.g., on a monthly basis) or based on a detected occurrence of a triggering event. In other examples, one or more of the elements of customer data may be associated with a customer-specific request for an unsecured credit product (e.g., received at issuer system 203 from a device operable by a corresponding one of the customers), and FI computing system 130 may perform operations that generate the input dataset for that corresponding customer in real-time and contemporaneously with the receipt of the one or more elements of the customer data from issuer system 203.

Further, and based on the one or more obtained model parameters, FI computing system 130 may perform any of the exemplary processes described herein to apply the adaptively trained machine-learning or artificial-intelligence process (e.g., the adaptively trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4). For example, and based on the one or more obtained model parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the customer-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the customer-specific input datasets and that generate the customer-specific elements of the output data associated with the customer-specific input datasets.

As described herein, each of the customer-specific elements of the output data may include a numerical score indicative of a predicted likelihood that a corresponding one of the customers will be involved in an insolvency event during the future temporal interval. In some examples, the numerical score within each of the customer-specific elements of the output data may range from zero to unity, with zero being indicative of a minimal predicted likelihood, and unity being indicative of a maximum predicted likelihood. Further, and as described herein, the future temporal interval may include, but is not limited to, a twelve-month period, and each of the numerical scores may be indicative of the predicted likelihood that the corresponding one of the customers will be involved in an insolvency event between three and fifteen months subsequent to a corresponding prediction date (e.g., the prediction date t_{pred} described herein).

In step 412 of FIG. 4, FI computing system 130 may also perform any of the exemplary processes described herein to post-process the customer-specific elements of output data and, among other things, associated each of the customer-specific elements of output data with a corresponding one of the customer identifiers and in some instances, with a corresponding one of the system identifiers, e.g., as maintained within the elements of customer data). Further, FI computing system 130 mat also perform any of the exemplary processes to rank the associated elements of customer data and the customer-specific elements of output data based on magnitudes of the corresponding numerical scores, which indicate the predicted likelihood that corresponding ones of the customers will be involved in an insolvency event during the future temporal interval, and generate elements of ranked output data that include the associated, and now ranked, elements of customer data and the elements of customer-specific output data (e.g., in step 414 of FIG. 4).

In some instances, by ranking the associated elements of elements of customer data and output data in accordance with the respective numerical scores, FI computing system 130 may identify those customers of the financial institution that represent the greatest insolvency risk to the financial institution during the future temporal interval. Further, and based on the corresponding system identifier, FI computing system 130 may perform any of the exemplary processes described herein to transmit all, or a selected portion of, the elements of ranked output data 236 to a corresponding one of the additional computing systems associated with the financial institution, which include, but are not limited to, a corresponding one of issuer systems 201, such as issuer system 203 (e.g., in step 416 of FIG. 4). As described herein, one or more of issuer system 201, such as issuer system 203, may receive a corresponding portion of the ranked elements of predictive output data from FI computing system 130, and may perform any of the exemplary processes described herein to that parse each the elements of ranked output data to obtain a corresponding numerical score for a corresponding customer, based on the corresponding numerical score, to modify one or more terms or conditions of an issued, unsecured credit product to reflect the predicted likelihood that the corresponding customer will be involved in an insolvency event during the future temporal interval. Exemplary process 400 is then complete in step 418.

### III. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interfaces (APIs) 134, 204, and 237, data ingestion engine 136, pre-processing engine 140, training engine 162, training input module 166, adaptive training and validation module 172, model input engine 212, predictive engine 228, post-processing engine 232, and credit modification engine 240, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data associated with a first temporal interval;
apply a trained artificial intelligence process to the input dataset, and based on the application of the trained artificial intelligence process to the input dataset, generate output data representative of a predicted likelihood of an occurrence of an event during a second temporal interval, the second temporal interval being subsequent to the first temporal interval and being separated from the first temporal interval by a corresponding buffer interval; and
transmit at least a portion of the generated output data to a computing system via the communications interface, the computing system being configured to generate or modify second interaction data based on the portion of the output data.

2. The apparatus of claim 1, wherein the at least one processor is further configured to:
receive at least a portion of the first interaction data from the computing system via the communications interface; and
store the received portion of the first interaction data within the memory.

3. The apparatus of claim 1, wherein the at least one processor is further configured to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 1, wherein the at least one processor is further configured to:
based on the data that characterizes the composition, perform operations that at least one of extract a first feature value from the first interaction data or compute a second feature value based on the first feature value; and
generate the input dataset based on at least one of the extracted first feature value or the computed second feature value.

5. The apparatus of claim 1, wherein the output data comprises a numerical score indicative of the predicted likelihood of the occurrence of the event during the second temporal interval.

6. The apparatus of claim 1, wherein the trained artificial intelligence process comprises a trained, gradient-boosted, decision-tree process.

7. The apparatus of claim 1, wherein:
the event comprises an insolvency event associated with a customer;
the first interaction data comprises a customer identifier associated with the customer and a temporal identifier associated with the first temporal interval; and
the at least one processor is further configured to execute the instructions to:
receive the customer identifier from the computing system via the communications interface; and
obtain the elements of the first interaction data from a portion of the memory based on the received customer identifier.

8. The apparatus of claim 1, wherein:
the first interaction data is associated with a plurality of customers; and
the at least one processor is further configured to execute the instructions to:
generate a plurality of input datasets based on the first interaction data, each of the plurality of input datasets being associated with a corresponding one of the customers;
apply the trained artificial intelligence process to each of the plurality of input datasets, and based on the application of the trained artificial intelligence to each of the plurality of input datasets, generate an element of the output data representative of the predicted likelihood of the occurrence of the insolvency event involving the corresponding one of the customers during the second temporal interval.

9. The apparatus of claim 8, wherein:
each of the generated elements of output data includes a numerical score indicative of the predicted likelihood of the occurrence of the insolvency event involving the corresponding one of the customers; and
the at least one processor is further configured to execute the instructions to:
perform operations that rank the generated elements of output data based on the numerical scores; and
transmit at least a portion of the ranked elements of output data to the computing system via the communications interface.

10. The apparatus of claim 1, wherein the at least one processor is further configured to execute the instructions to:
obtain elements of third interaction data, each of the elements of the third interaction data comprising a temporal identifier associated with a temporal interval;
based on the temporal identifiers, determine that a first subset of the elements of the third interaction data are associated with a prior training interval, and that a second subset of the elements of the third interaction data are associated with a prior validation interval; and
generate a plurality of training datasets based corresponding portions of the first subset, and perform operations that train the artificial intelligence process based on the training datasets.

11. The apparatus of claim 10 wherein the at least one processor is further configured to execute the instructions to:
generate a plurality of the validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

12. The apparatus of claim 1, wherein:
the event comprises an insolvency event associated with a customer;
the output data is representative of the predicted likelihood of the occurrence of the insolvency event associated with the customer during the second temporal interval;
the second interaction data comprises a term or condition of a financial product held by the customer; and
the computing system is further configured to generate or modify the term or condition based on the predicted likelihood of the occurrence of the insolvency event during the second temporal interval.

13. A computer-implemented method, comprising:
generating, using at least one processor, an input dataset based on elements of first interaction data associated with a first temporal interval;
using the at least one processor, applying a trained artificial intelligence process to the input dataset, and based on the application of the trained artificial intelligence process to the input dataset, generating output data representative of a predicted likelihood of an occurrence of an event during a second temporal interval, the second temporal interval being subsequent to the first temporal interval and being separated from the first temporal interval by a corresponding buffer interval; and
transmitting, using the at least one processor, at least a portion of the generated output data to a computing system, the computing system being configured to generate or modify second interaction data based on the portion of the output data.

14. The computer-implemented method of claim 13, further comprising:
receiving, using the at least one processor, at least a portion of the first interaction data from the computing system; and
storing, using the at least one processor, the received portion of the first interaction data within a data repository.

15. The computer-implemented method of claim 13, wherein the trained artificial intelligence process comprises a trained, gradient-boosted, decision-tree process.

16. The computer-implemented method of claim 13, wherein:
the event comprises an insolvency event associated with a customer;
the output data comprises a numerical score indicative of the predicted likelihood of the occurrence of the insolvency event during the second temporal interval;
the first interaction data comprises a customer identifier associated with the customer and a temporal identifier associated with the first temporal interval; and
the computer-implemented method further comprises:
receiving, using the at least one processor, the customer identifier from the computing system; and
obtaining, using the at least one processor, the elements of the first interaction data from a data repository based on the received customer identifier.

17. The computer-implemented method of claim 13, wherein:
the first interaction data is associated with a plurality of customers; and
the computer-implemented method further comprises:
generating, using the at least one processor, a plurality of input datasets based on the first interaction data, each of the plurality of input datasets being associated with a corresponding one of the customers; and
using the at least one processor, applying the trained artificial intelligence process to each of the plurality of input datasets, and based on the application of the trained artificial intelligence process to each of the plurality of input datasets, generating an element of the output data representative of the predicted likelihood of the occurrence of the insolvency event involving the corresponding one of the customers during the second temporal interval.

18. The computer-implemented method of claim 17, wherein:
each of the generated elements of output data includes a numerical score indicative of the predicted likelihood of the occurrence of the insolvency event involving the corresponding one of the customers; and
the computer-implemented method further comprises:
performing, using the at least one processor, operations that rank the generated elements of output data based on the numerical scores; and
transmitting, using the at least one processor, at least a portion of the ranked elements of output data to the computing system.

19. The computer-implemented method of claim 13, wherein:
the event comprises an insolvency event associated with a customer;
the output data is representative of the predicted likelihood of the occurrence of the insolvency event associated with the customer during the second temporal interval;
the second interaction data comprises a term or condition of a financial product held by the customer; and
the computing system is further configured to modify the term or condition based on the predicted likelihood of the occurrence of the insolvency event during the second temporal.

20. A tangible, non-transitory computer-readable medium storing instructions that, when executed by at least one processor, cause the at least one processor to perform a method, comprising:
generating an input dataset based on elements of first interaction data associated with a first temporal interval;
applying a trained artificial intelligence process to the input dataset, and based on the application of the trained artificial intelligence process to the input dataset, generating output data representative of a predicted likelihood of an occurrence of an event during a second temporal interval, the second temporal interval being subsequent to the first temporal interval and being separated from the first temporal interval by a corresponding buffer interval; and
transmitting at least a portion of the generated output data to a computing system, the computing system being configured to generate or modify second interaction data based on the portion of the output data.
